(19) United States
(12) Patent Application Publication
(10) Pub. No.: US 2015/0100711 A1
(43) Pub. Date: Apr. 9, 2015

(54) LOW POWER CAMERA CONTROL INTERFACE BUS AND DEVICES

(71) Applicant: QUALCOMM Incorporated, San Diego, CA (US)

(72) Inventor: Shoichiro Sengoku, San Diego, CA (US)

(21) Appl. No.: 14/485,627

(22) Filed: Sep. 12, 2014

Related U.S. Application Data
(60) Provisional application No. 61/887,891, filed on Oct. 7, 2013.

(51) Int. Cl. G06F 13/40; G06F 13/36

(52) U.S. Cl. CPC G06F 13/4068; G06F 13/36
USPC 710/106

(57) ABSTRACT

System, methods and apparatus are described for extracting data and clocks from a camera control interface bus. A transmit clock may be generated while transmitting symbols on the bus, and a receive clock may be extracted when receiving symbols from the bus. A heartbeat clock may be extracted by from symbols transmitted on the bus when the apparatus is not transmitting or receiving symbols. The transmit clock may be used to encode data in a sequence of symbols for transmission on a pair of connectors of the bus. The receive clock may be extracted by detecting transitions occurring between symbols transmitted on the bus, and generating the receive clock based on the transitions. The heartbeat clock may be used to control operations of the apparatus, or synchronize one or more function of the apparatus. The heartbeat clock may be encoded in a control word transmitted on the bus.

### CROSS-REFERENCE TO RELATED APPLICATIONS

This application claims priority to and the benefit of U.S. provisional patent application No. 61/887,891 filed Oct. 7, 2013, the entire content of which being incorporated herein by reference.

### BACKGROUND

1. Field

The present disclosure relates generally to high-speed data communications interfaces, and more particularly, clock recovery and management in camera control communication links.

2. Background

Manufacturers of mobile devices, such as cellular phones, may obtain components of the mobile devices from various sources, including different manufacturers. For example, an application processor in a cellular phone may be obtained from a first manufacturer, while the camera for the cellular phone may be obtained from a second manufacturer. The application processor and a camera or other device may be interconnected using a standards-based or proprietary physical interface. For example, a camera may provide an interface that conforms to a Camera Serial Interface standard specified by the Mobile Industry Processor Interface Alliance (MIPI).

MIPI standards define a camera control interface (CCI) that uses a two-wire, bi-directional, half duplex, serial interface configured as a bus connecting a master and one or more slaves. Conventional CCI is compatible with certain protocols used for communication on the Inter-Integrated Circuit (I2C) bus and CCI is capable of handling multiple slaves on the bus, with a single master. The CCI bus may include Serial Clock (SCL) and Serial Data (SDA) lines.

The use of devices such as cameras may necessitate the use of a high bit-rate communications interface. In many instances, generation and use of a transmitter clock that supports the high bit-rate communications interface results in significantly increased power consumption by processing systems collocated with the camera. Accordingly, there exists an ongoing need for providing reduced-power, high-speed communications capabilities.

### SUMMARY

Embodiments disclosed herein provide systems, methods and apparatus for extracting clock information and data from a communications link that has improved low-power performance and other capabilities. Devices coupled to the communications link, and adapted according to certain aspects disclosed herein, may discontinue or disable internal clock sources when operating in an idle mode in order to reduce power consumption. The devices may continue to operate to some degree and maintain certain functionalities using a clock signal received or derived from the communications link. In some instances, a device coupled to the communications link may have no internal clock source and may rely on a clock signal received or derived from the communications link.

According to certain aspects disclosed herein, a CCI extension (CCIe) bus may be operated in an idle mode such that a slave device coupled to the CCIe bus may extract a heartbeat clock that has a frequency that is significantly lower than the symbol transmission rate of the CCIe bus. In the idle mode, a master device may repetitively transmit a heartbeat word consistent with CCIe protocols and in a manner that enables an idled slave device to extract the lower frequency heartbeat clock from the CCIe bus.

Certain aspects of the disclosure relate to a method of data communications that may be performed by a master device on a serial bus. The method may include transmitting a first plurality of words at a first rate on a CCIe bus during a first mode of operation, the first plurality of words including data or control information, and repetitively transmitting a predefined control word at a second rate on the CCIe bus during a second mode of operation. A second plurality of words may be transmitted at the first rate on the CCIe bus upon termination of the second mode of operation. The second rate may be lower than the first rate. Each word transmitted on the CCIe bus may be transmitted in a sequence of symbols, where each pair of consecutive symbols in the sequence of symbols includes two different symbols. A receiver may be configured to extract a receive clock from transitions in the signaling state of the CCIe bus when two or more symbols are transmitted on the CCIe bus.

In an aspect of the disclosure, the predefined control word may cause a single pulse to be transmitted on a first wire of the CCIe bus for each predefined control word transmitted on the CCIe bus.

In an aspect of the disclosure, the second rate is obtained by introducing delays between groups of symbols in a sequence of symbols corresponding to the predefined control word. The delays may be introduced between the groups of symbols such that both wires of the CCIe bus are undriven for the duration of each delay.

In an aspect of the disclosure, transmitting the predefined control word generates a synchronization pattern in the signaling state of the CCIe bus. Transmitting the predefined control word may include transmitting a sequence of symbols corresponding to the predefined control word as groups of symbols. Each pair of consecutive groups of symbols may be separated by a delay. Each group of symbols may cause a pulse to be transmitted on a first wire of the CCIe bus and may cause a signaling state of a second wire of the CCIe bus to remain unchanged while the pulse is transmitted on the first wire.

In an aspect of the disclosure, transmitting the predefined control word includes dividing the sequence of symbols corresponding to the predefined control word into groups of three symbols. Each group of three symbols may be transmitted on the CCIe bus at a first symbol transmission rate, and transmission of a first symbol in a next group of three symbols may then be delayed. Transmitting the first plurality of words may include transmitting sequences of symbols corresponding to the first plurality of words at the first symbol transmission rate.

In an aspect of the disclosure, each symbol in the sequence of symbols determines the signaling state of at least two wires of the CCIe bus while the symbol is transmitted on the CCIe bus.

Certain aspects of the disclosure relate to an apparatus that may be configured or adapted to operate as a master device on a CCIe bus. The apparatus may include a processing circuit configured to transmit a first plurality of words at a first rate on a CCIe bus during a first mode of operation, the first plurality of words including data or control information, repetitively transmit a predefined control word at a second rate on the CCIe bus during a second mode of operation, and transmit a second plurality of words at the first rate on the CCIe bus upon termination of the second mode of operation. The second rate may be lower than the first rate. Each word transmitted on the CCIe bus may be transmitted in a sequence of symbols, where each pair of consecutive symbols in the sequence of symbols includes two different symbols. A receiver may be configured to extract a receive clock from transitions in signaling state of the CCIe bus when two or more symbols are transmitted on the CCIe bus.

Certain aspects of the disclosure relate to an apparatus that may be configured or adapted to operate as a master device on a CCIe bus. The apparatus may include means for transmitting a first plurality of words at a first rate on a CCIe bus during a first mode of operation, the first plurality of words including data or control information, means for repetitively transmitting a predefined control word at a second rate on the CCIe bus during a second mode of operation, and means for transmitting a second plurality of words at the first rate on the CCIe bus upon termination of the second mode of operation. The second rate may be lower than the first rate. Each word transmitted on the CCIe bus may be transmitted in a sequence of symbols, where each pair of consecutive symbols in the sequence of symbols includes two different symbols. A receiver may be configured to extract a receive clock from transitions in signaling state of the CCIe bus when two or more symbols are transmitted on the CCIe bus.

Certain aspects of the disclosure relate to a storage medium that may include or maintain instructions and data. In one example, the storage medium includes a non-transient storage medium. When executed, the instructions may cause one or more processors to transmit a first plurality of words at a first rate on a CCIe bus during a first mode of operation, the first plurality of words including data or control information, repetitively transmit a predefined control word at a second rate on the CCIe bus during a second mode of operation, and transmit a second plurality of words at the first rate on the CCIe bus upon termination of the second mode of operation. The second rate may be lower than the first rate. Each word transmitted on the CCIe bus may be transmitted in a sequence of symbols, where each pair of consecutive symbols in the sequence of symbols includes two different symbols. A receiver may be configured to extract a receive clock from transitions in signaling state of the CCIe bus when two or more symbols are transmitted on the CCIe bus.

Certain aspects of the disclosure relate to a method of data communications that may be performed by a slave device on a serial bus. The method may include generating a transmit clock while in a transmitting mode of operation, extracting a receive clock from transitions in signaling state of the CCIe bus while another device is transmitting information on the CCIe bus, refraining from generating at least one clock signal during a hibernate or idle mode of operation, and using the receive clock to control one or more operations of the slave device during the hibernate or idle mode of operation. The transmit clock may be used to encode data or control information in a sequence of symbols to be transmitted on a pair of connectors of the CCIe bus. Each pair of consecutive symbols transmitted on the CCIe bus may include two different symbols.

In an aspect of the disclosure, the method includes refraining from generating the transmit clock when the slave device is not transmitting symbols on the CCIe bus.

In an aspect of the disclosure, the receive clock has a longer period when the CCIe bus is in an idle mode of operation than when data or control information is transmitted between two nodes of the CCIe bus.

In an aspect of the disclosure, extracting the receive clock includes extracting a heartbeat clock from symbols transmitted on the CCIe bus when the CCIe bus is in an idle mode of operation. The heartbeat clock may be extracted from a sequence of symbols corresponding to a predefined control word. The heartbeat clock may have a lower frequency than a receive clock extracted from the CCIe bus when data or control information is transmitted between two nodes of the CCIe bus.

In an aspect of the disclosure, a synchronization pattern may be determined in transitions of the signaling state of the CCIe bus. The synchronization pattern may be generated by a sequence of symbols corresponding to a predefined control word transmitted on the CCIe bus when the CCIe bus is in an idle mode of operation.

Certain aspects of the disclosure relate to an apparatus that may be configured or adapted to operate as a slave device on a CCIe bus. The apparatus may include a processing circuit configured to generate a transmit clock while in a transmitting mode of operation, extract a receive clock from transitions in signaling state of the CCIe bus while another device is transmitting information on the CCIe bus, refrain from generating at least one clock signal during a hibernate or idle mode of operation, and use the receive clock to control one or more operations during the hibernate or idle mode of operation. The transmit clock may be used to encode data or control information in a sequence of symbols to be transmitted on a pair of connectors of the CCIe bus. Each pair of consecutive symbols transmitted on the CCIe bus may include two different symbols.

Certain aspects of the disclosure relate to an apparatus that may be configured or adapted to operate as a slave device on a CCIe bus. The apparatus may include means for generating a transmit clock while in a transmitting mode of operation, means for extracting a receive clock from transitions in signaling state of the CCIe bus while another device is transmitting information on the CCIe bus, means for refraining from generating at least one clock signal during a hibernate mode of operation, and means for using the receive clock to control one or more operations during the hibernate mode of operation. The transmit clock may be used to encode data or control information in a sequence of symbols to be transmitted on a pair of connectors of the CCIe bus. Each pair of consecutive symbols transmitted on the CCIe bus may include two different symbols.

Certain aspects of the disclosure relate to a storage medium that may include or maintain instructions and data. In one example, the storage medium includes a non-transient storage medium. When executed, the instructions may cause one or more processors to generate a transmit clock while in a transmitting mode of operation, extract a receive clock from transitions in signaling state of the CCIe bus while another device is transmitting information on the CCIe bus, refrain from generating at least one clock signal during a hibernate or idle mode of operation, and use the receive clock to control one or more operations during the hibernate or idle mode of operation. The transmit clock may be used to encode data or control information in a sequence of symbols to be transmitted on a pair of connectors of the CCIe bus. Each pair of consecutive symbols transmitted on the CCIe bus may include two different symbols.

### BRIEF DESCRIPTION OF THE DRAWINGS

FIG. 1 depicts an apparatus employing a data link between IC devices that selectively operates according to one of plurality of available standards.

FIG. 2 illustrates a system architecture for an apparatus employing a data link between IC devices.

FIG. 3 is a timing diagram illustrating an I2C one byte write data operation.

FIG. 4 is a timing chart illustrating an example of data transmissions on a serial bus in accordance with CCIe protocols.

FIG. 5 illustrates certain aspects of a transmitter and a receiver according to certain aspects disclosed herein.

FIG. 6 illustrates an encoding scheme for transcoding data according to certain aspects disclosed herein.

FIG. 7 illustrates a simplified example of certain aspects of a CCIe protocol.

FIG. 8 illustrates one example of a clock and data recovery circuit that may be used in a receiver adapted according to certain aspects disclosed herein.

FIG. 9 illustrates timing of certain signals generated by a clock and data recovery circuit according to one or more aspects disclosed herein.

FIG. 10 illustrates certain aspects of a heartbeat clock provided according to one or more aspects disclosed herein.

FIG. 11 illustrates the encoding of a heartbeat word in symbols transmitted on a CCIe bus according to one or more aspects disclosed herein.

FIG. 12 illustrates a heartbeat clock generated using the heartbeat word according to one or more aspects disclosed herein.

FIG. 13 is a first state diagram illustrating a process for synchronization using a heartbeat clock provided according to one or more aspects disclosed herein.

FIG. 14 illustrates an example of a transmission sequence that can mimic a synchronization word provided using a heartbeat clock provided according to one or more aspects disclosed herein.

FIG. 15 is a second state diagram illustrating a process for synchronization using a heartbeat clock provided according to one or more aspects disclosed herein.

FIG. 16 is a block diagram illustrating an example of an apparatus employing a processing circuit that may be adapted according to certain aspects disclosed herein.

FIG. 17 is a flow chart of a method for data communications performed by a CCIe master device according to one or more aspects disclosed herein.

FIG. 18 is a diagram illustrating an example of a hardware implementation for a CCIe master device according to one or more aspects disclosed herein.

FIG. 19 is a flow chart of a method for data communications performed by a CCIe slave device according to one or more aspects disclosed herein.

FIG. 20 is a diagram illustrating an example of a hardware implementation for a CCIe slave device according to one or more aspects disclosed herein.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as, but not limited to hardware, firmware, a combination of hardware and software, software, or software in execution. For example, a component may be, but is not limited to being, a process running on a processor, a processor, an object, an executable, a thread of execution, a program and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

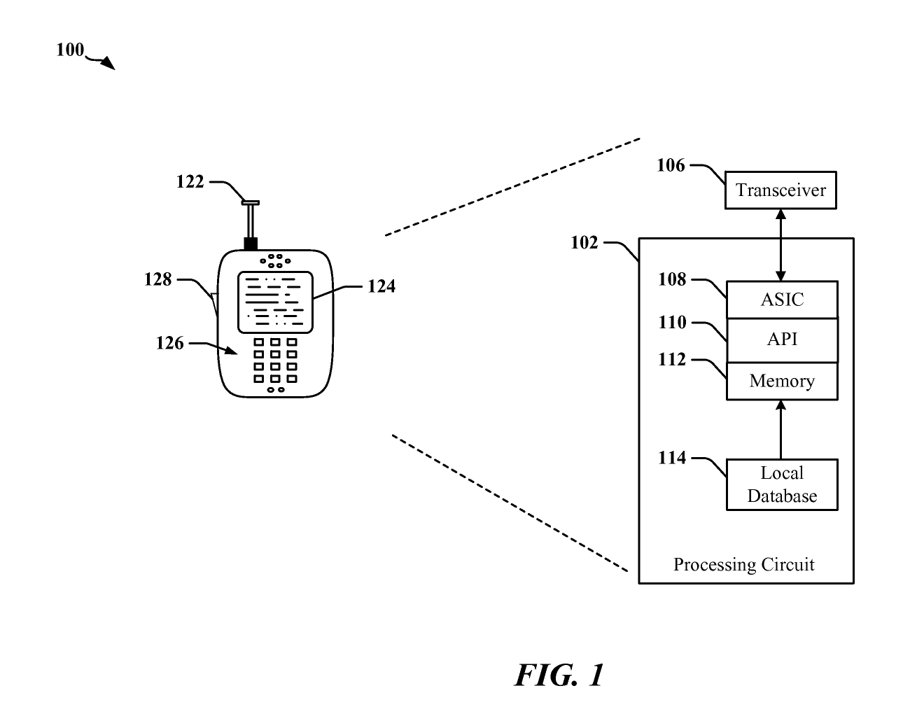

Certain aspects of the invention may be applicable to communications links deployed between electronic devices that may include subcomponents of an apparatus such as a telephone, a mobile computing device, an appliance, automobile electronics, avionics systems, etc. FIG. 1 depicts an apparatus that may employ a communication link between IC devices. In one example, the apparatus 100 may include a wireless communication device that communicates through an RF transceiver with a radio access network (RAN), a core access network, the Internet and/or another network. The apparatus 100 may include a communications transceiver 106 operably coupled to processing circuit 102. The processing circuit 102 may include one or more IC devices, such as an application-specific IC (ASIC) 108. The ASIC 108 may include one or more processing devices, logic circuits, and so on. The processing circuit 102 may include and/or be coupled to processor readable storage such as a memory 112 that may maintain instructions and data that may be executed by the processing circuit 102. The processing circuit 102 may be controlled by one or more of an operating system or an application programming interface (API) 110 layer that supports and enables execution of software modules residing in storage media, such as the memory device 112 of the wireless device. The memory device 112 may include read-only memory (ROM) or random-access memory (RAM), electrically erasable programmable ROM (EEPROM), flash cards, or any memory device that can be used in processing systems and computing platforms. The processing circuit 102 may include or access a local database 114 that can maintain operational parameters and other information used to configure and operate apparatus 100. The local database 114 may be implemented using one or more of a database module, flash memory, magnetic media, EEPROM, optical media, tape, soft or hard disk, or the like. The processing circuit 102 may also be operably coupled to external devices such as antenna 122, display 124, operator controls, such as button 128 and keypad 126 among other components.

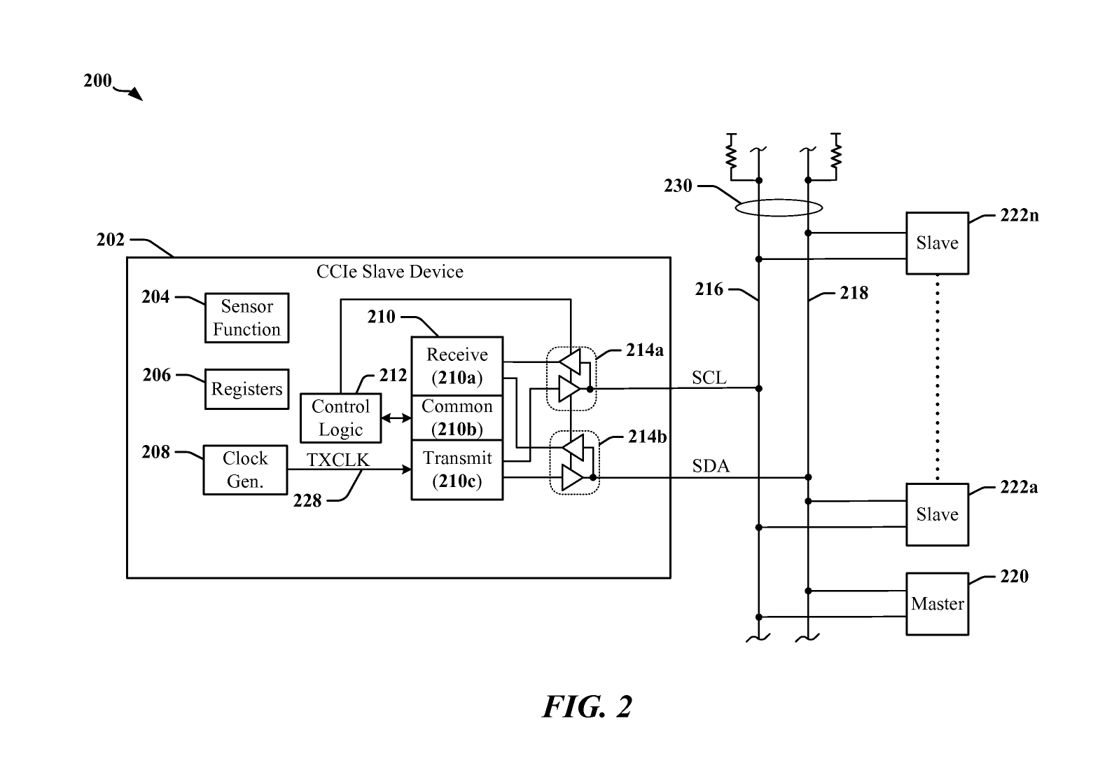

FIG. 2 is a block schematic illustrating certain aspects of an apparatus 200 connected to a communications bus, where the apparatus may be embodied in one or more of a wireless mobile device, a mobile telephone, a mobile computing system, a wireless telephone, a notebook computer, a tablet computing device, a media player, a gaming device, a wearable computing device, an appliance, a vehicle, or the like. The apparatus 200 may include multiple devices 202, 220 and 222a-222n, which communicate using a serial bus 230. According to certain aspects disclosed herein, two or more of the devices 202, 220 and/or 222a-222n may be configured or adapted to use the serial bus 230 in a CCIe mode of operation. In the CCIe mode of operation, the serial bus 230 may be referred to as the CCIe bus 230. The CCIe bus 230 may provide higher data transfer rates between devices 202, 220 and/or 222a-222n that are compatible with CCIe bus operations. Such devices 202, 220 and/or 222a-222n may be referred to as CCIe devices. The CCIe devices 202, 220 and/or 222a-222n may attain higher data rates when communicating with each other by encoding data as symbols transmitted on both the SCL line and the SDA line of a conventional CCI bus or I2C bus. CCIe devices, CCI and/or I2C devices may coexist on the same CCIe bus 230. For example, data may be transmitted using CCIe encoding in a first time interval, and other data may be transmitted according to I2C signaling conventions in a different time interval.

The CCIe bus 230 can extend the capabilities of a conventional I2C or CCI bus for devices that are configured for enhanced features supported by the CCIe bus 230. For example, the CCIe bus 230 may support a higher bit rate than an I2C or CCI bus. According to certain aspects disclosed herein, some versions of the CCIe bus 230 may be configured or adapted to support bit rates of 16.7 Mbps or more, and some versions of the CCIe bus 230 may be configured or adapted to support data rates of at least 23 megabits per second.

The apparatus 200 may include a camera and/or may be configured to control certain camera operations. In one example, an imaging device 202 is configured to operate as a slave device on the CCIe bus 230. The imaging device 202 may be adapted to provide a sensor control function 204 that manages an image sensor, for example. In addition, the imaging device 202 may include configuration registers or other storage 206, control logic 212, a transceiver 210 and line drivers/receivers 214a and 214b. The control logic 212 may include a processing circuit such as a state machine, sequencer, signal processor or general-purpose processor. The transceiver 210 may include a receiver 210a, a transmitter 210c and common circuits 210b, including timing, logic and storage circuits and/or devices. In one example, the transmitter 210c encodes and transmits data based on timing provided by a clock generation circuit 208.

A conventional imaging device 204 may not have access to a clock that has a high enough frequency to permit the device 202 to achieve the indicated bit rate of the CCIe bus 230, because sensor devices 202 typically do not need or use a 125 MHz or higher clock. According to certain aspects disclosed herein, however, a receiver 210a may be configured or adapted to extract a receive clock from the CCIe bus 230 by generating a clock signal directly from the received transmission using analog delay circuits that can eliminate the need for a high frequency clock and thereby conserve power during idle periods.

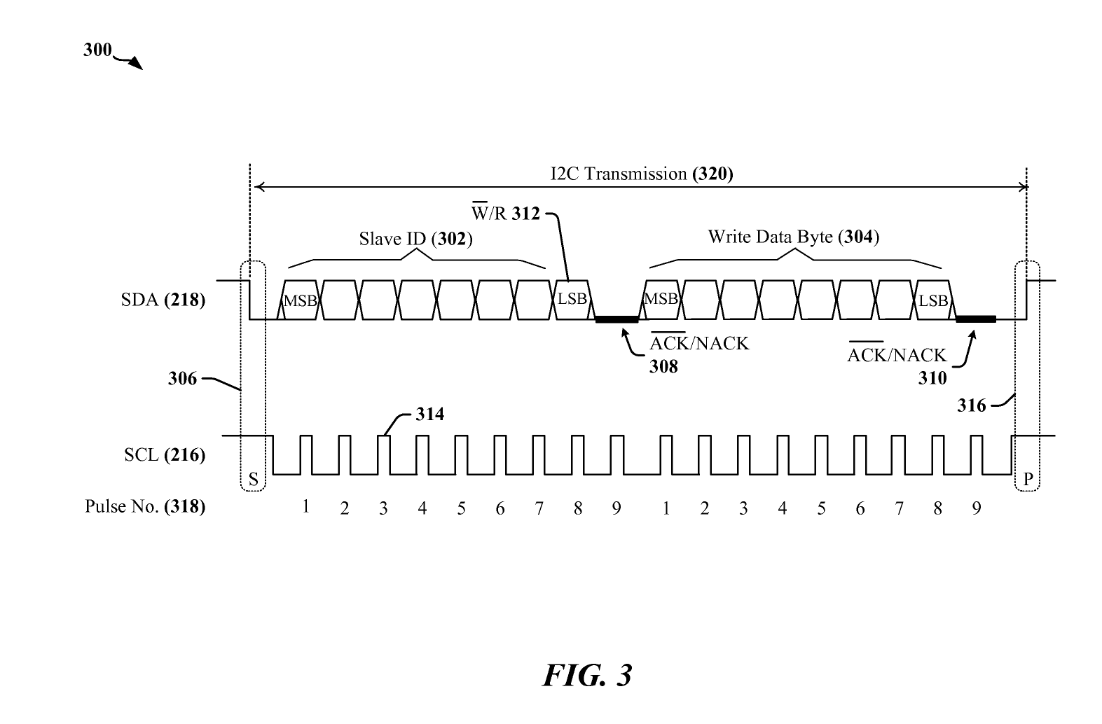

FIG. 3 is a timing diagram 300 illustrating an example of single-byte write data operation when the serial bus 230 is operated in accordance with I2C protocols. Each I2C transmission 320 commences with a start condition 306 that is asserted on the serial bus 230, and terminates when a stop condition 316 is asserted on the serial bus 230. The start condition 306 is asserted when the SDA signal wire 218 transitions low while the SCL signal wire 216 is held in a high state. The stop condition 316 is asserted when the SDA signal wire 218 transitions high while the SCL signal wire 216 is held in a high state. According to I2C protocols, transitions on the SDA signal wire 218 occur when the SCL signal wire 216 is low, except for start condition 306 and stop conditions 316.

In typical I2C operations, an I2C master node sends a 7-bit slave ID 302 on the SDA signal wire 218 to indicate which slave node on the I2C bus the master node wishes to access, followed by a Read/Write bit 312 that indicates whether the operation is a read or a write operation, whereby the Read/Write bit 312 is at logic 0 to indicate a write operation and at logic 1 to indicate a read operation. Only the slave node whose ID matches with the 7-bit slave ID 302 is permitted respond to the write (or any other) operation. In order for an I2C slave node to detect its own ID 302, the master node transmits at least 8-bits on the SDA line 218, together with 8 clock pulses on the SCL line 216. This behavior may be exploited to transmit data in CCIe operating modes in order to prevent legacy I2C slave nodes from reacting to CCIe operations.

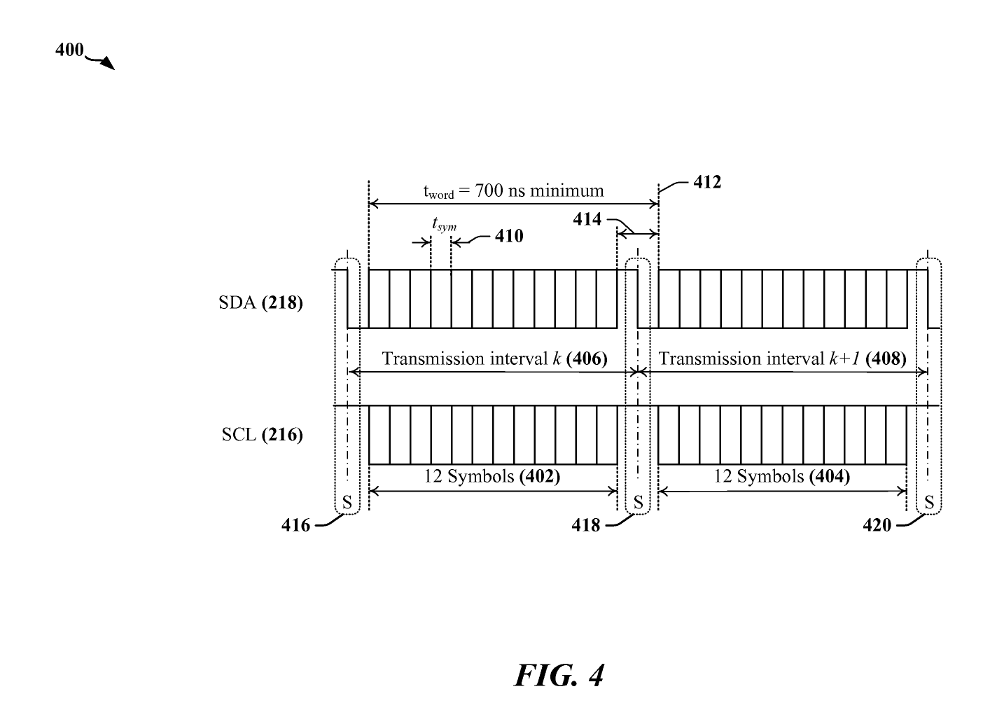

FIG. 4 is a timing diagram 400 that illustrates data transmission on a serial bus 230 that is operated in accordance with CCIe protocols, and when two or more communicating devices 202, 220, 222a-222n are configured or adapted to communicate in accordance with CCIe protocols. In a CCIe mode of operation, data is encoded into a set of two-bit symbols transmitted sequentially on the signal wires 216, 218 of the CCIe bus 230. Sequences of symbols 402, 404 may be transmitted in successive transmission intervals 406, 408. Each sequence of symbols 402, 404 is preceded by a start condition 416, 418, 420. The start conditions 416, 418, 420 are asserted when the SDA signal wire 218 transitions low while the SCL signal wire 216 is held in a high state. According to CCIe protocols, transitions on the SDA signal wire 218 may occur at the same time that transitions occur on the SCL signal wire 216 when a sequence of symbols 402, 404 is being transmitted. Start conditions 416, 418, 420 may occupy two symbol intervals.

In the illustrated example, each sequence of symbols 402, 404 includes 12 symbols and encodes 20-bit data elements that may include 16 bits of data and 3 bits of overhead. Each symbol in the sequence of 12 symbols 402, 404 defines the signaling state of the SDA signal wire 218 and the SCL signal wire 216 for each symbol period (t_{sym}) 410. In one example, push-pull drivers 214a, 214b used to drive the signal wires 216, 218 may support a symbol period 410 of 50 ns duration, using a 20 MHz symbol clock. The two-symbol sequence, which may be denoted as {3,1}, is transmitted in the period 414 between consecutive sequences of symbols 402 and 404 to provide a start condition 418. For the resulting 14-symbol transmission (12 symbols payload and a start condition 416, 418, or 420), the minimum elapsed time 412 between the start of a first transmission 406 and the start of a second transmission 408 may be calculated as:

t_{word}=14×t_{sym}=700 ns.

Thus, 20 bits may be transmitted every 700 ns, yielding a raw bit rate of approximately 28.6 Mbps with a useful bit rate of approximately 22.86 Mbps, since 16 data bits are transmitted in each 12 symbol word 406, 408.

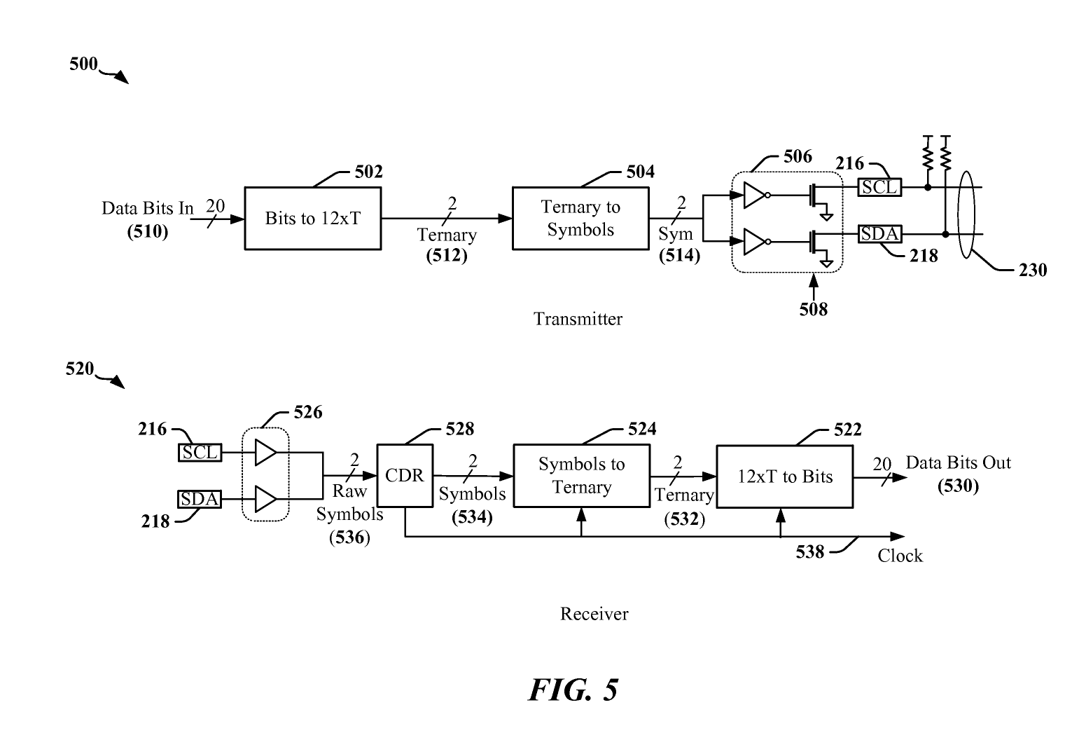

FIG. 5 is a block diagram illustrating an example of a transmitter 500 and a receiver 520 configured according to certain aspects disclosed herein. For CCIe operations, the transmitter 500 may transcode data 510 into ternary (base-3) transition numbers 512 that are used to select symbols for transmission on the SCL 216 and SDA 218 signal wires. In the example depicted, each data element (also referred to as a data word) of the input data 510 may have 19 or 20 bits. A transcoder 502 may receive the input data 510 and produce a sequence of ternary numbers 512 for each data element. The ternary numbers 512 may be encoded in two bits and there may be 12 ternary numbers in each ternary sequence 512. An encoder 504 produces a stream of 2-bit symbols 514 that are transmitted through line drivers 506. In the example depicted, the line drivers 506 include open-drain output transistors 508. However, in other examples, the line drivers 506 may drive the SCL 216 and SDA 218 signal wires using push-pull drivers (such as the drivers 214a, 214b in FIG. 2). A transition is provided in the state of at least one of the SCL signal wire 216 and the SDA signal wire 218 between consecutive symbols in the output stream of 2-bit symbols 514. The encoder 504 may provide the transitions between the consecutive symbols 514 by ensuring that no pair of consecutive symbols includes two identical symbols. The availability of a transition of state in at least one wire 216 and/or 218 permits a receiving circuit 520 to extract a receive clock 538 from the stream of data symbols 514.

In a CCIe system, the receiver 520 may include or cooperate with a clock and data recovery circuit (CDR) 528. The receiver 520 may include line interface circuits 526 that provide a stream of raw 2-bit symbols 536 to the CDR 528. The CDR 528 extracts a receive clock 538 from the raw symbols 536 and provides a stream of 2-bit symbols 534 with the receive clock 538 to other circuits 524 and 522 of the receiver 520. In some examples, the CDR 528 may produce multiple clocks 538. A decoder 524 may use the receive clock 538 to decode the stream of symbols 534 into sequences of 12 ternary numbers 532. The ternary numbers 532 may be encoded using two bits. A transcoder 522 may then convert each sequence of 12 ternary numbers 532 into 19-bit or 20-bit output data elements 530.

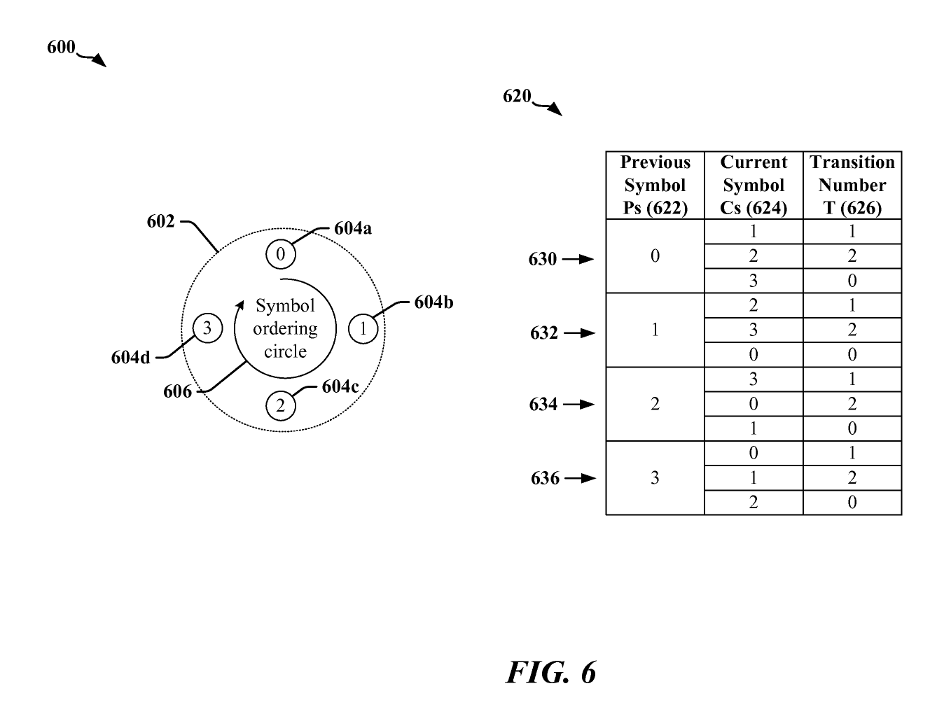

FIG. 6 is a drawing illustrating an encoding scheme 600 that may be used by the encoder 504 to produce a sequence of symbols 514 with embedded clock information for transmission on the CCIe bus 230. The encoding scheme 600 may also be used by a decoder 524 to extract ternary transition numbers from symbols received from the CCIe bus 230. In the CCIe encoding scheme 600, the two wires 216, 218 of the CCIe bus 230 permit definition of 4 basic symbols S: {0, 1, 2, 3}. Any two consecutive symbols in the sequence of symbols 514, 534 have different states, and the symbol sequences {0, 0}, {1, 1}, {2, 2} and {3, 3} are invalid combinations of consecutive symbols. Accordingly, only 3 valid symbol transitions are available at each symbol boundary, where the symbol boundary is determined by the transmit clock and represents the point at which a first symbol (previous symbol Ps) 622 terminates and a second symbol (current symbol Cs) 624 begins.

According to certain aspects disclosed herein, the three available transitions are assigned a transition number (T) 626 for each Ps symbol 622. The value of T 626 can be represented by a ternary number. In one example, the value of transition number 626 is determined by assigning a symbol ordering circle 602 for the encoding scheme. The symbol ordering circle 602 allocates locations 604a-604d on the circle 602 for the four possible symbols, and a direction of rotation 606 between the locations 604a-604d. In the depicted example, the direction of rotation 606 is clockwise. The transition number 626 may represent the separation between the valid current symbols 624 and the immediately preceding symbol 622. Separation may be defined as the number of steps along the direction of rotation 606 on the symbol ordering circle 602 required to reach the current symbol Cs 624 from the previous symbol 622. The number of steps can be expressed as a single digit base-3 number. It will be appreciated that a three-step difference between symbols can be represented as a 0_{base-3}. The table 620 in FIG. 6 summarizes an encoding scheme employing this approach.

At the transmitter 500, the table 620 may be used to lookup a current symbol 624 to be transmitted, given knowledge of the previously generated symbol 622 and an input ternary number, which is used as a transition number 626. At the receiver 520, the table 620 may be used as a lookup to determine a transition number 626 that represents the transition between the previously received symbol 622 and the currently received symbol 624. The transition number 626 may be output as a ternary number.

With continued reference to FIGS. 4-6, multiple bits of data 510 may be encoded in a sequence of symbols 514 for transmission in a single transmission interval 406, 408 on a serial bus 230. In one example, 20 bits of data 510 may be encoded in a sequence of 12 symbols 514, 402, 404 preceded by a two-symbol start condition 416. The content of the payload of each transmission 402, 404 may be determined and/or controlled by a CCIe protocol, which may define types of transmission and control mechanisms for ensuring reliable communication over the serial bus 230.

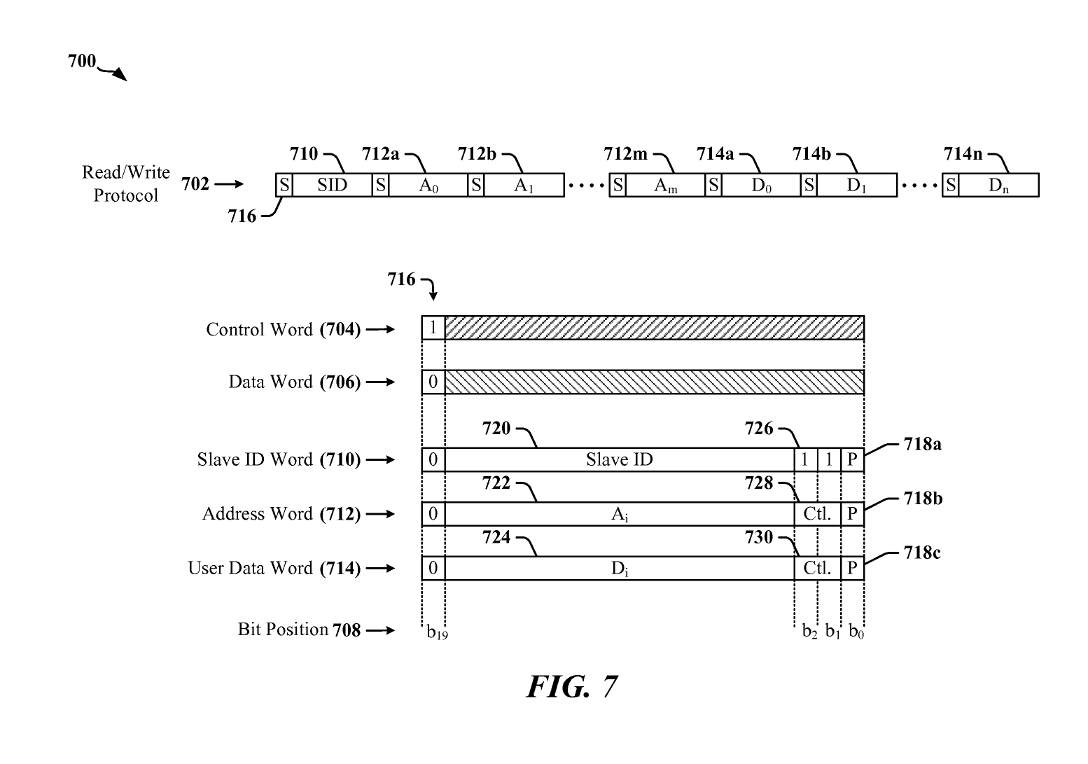

FIG. 7 is a simplified illustration of certain aspects of a CCIe protocol 700. The 20-bit element encoded in a transmission 402, 404 may be identified as including control information or data. The first transmitted bit (b₁₉) 716 of the 20 bits encoded in the 12 symbol transmission 402, 404 may be set to binary ‘1’ when control information 704 is being transmitted, and to binary ‘0’ when encoded user data 710, 712, 714 is being transmitted in the 12 symbol transmission 402, 404. Control information may include commands, status, register content and/or settings, and other information used to control and order communication between devices. The term user data may refer to 16-bit fields 724 of information that are defined based on an application or context. Different types of data words 710, 712, 714 may be defined and these data words 710, 712, 714 may include information such as a slave address or identifier 720, an address or portion of an address 722, or application data 724 to be read from or written to a previously identified memory address in a previously-identified slave node.

In the simplified example 700 illustrated in FIG. 7, a master device 220 on a CCIe serial bus 230 may perform a read or write operation from or to a slave node 202, 222a-222n by sending a slave identifier 710 in one or more transmissions, an address transmitted in one or more address words 712a, 712b, . . . 712m identifying the location to be read or written in one or more address transmissions 712, and the read/write user or application data may be transmitted in one or more user data transmission words 714a, 714b, . . . 714n.

In some instances, the slave ID word 710 includes a 16-bit node identifier 720. A two-bit field 726 transmitted after the slave ID 720 may be set to binary ‘11’ (decimal ‘3’). An additional protocol-defined (P) bit 718a may be provided to support error detection, or other protocol-related function. In one example, the P bit 718a may be a parity bit or another error detection value for the current word. In another example, the P bits 718a in a sequence of words may be used for error detection and/or correction for the sequence of words.

In some instances, each address word 712 includes a 16-bit address value, a 2-bit control code 728, and an additional protocol-defined (P) bit 718b. Multiple address words 712a, 712b, . . . 712m may be transmitted sequentially. An example of bit settings for the control code 728 is provided in Table 1. In the example illustrated, the control code 728 may be set to ‘00’ to indicate that another address word 712b, . . . 712m is to be transmitted after the current address word 712a, 712b. The control code 728 may be set to ‘01’ to indicate that a data word is to be transmitted as the next data word 714a. The control code 728 may be set to ‘10’ to indicate that a data word is to be read as the next data word 714a on the CCIe serial bus 230. The control code 728 may be set to ‘11’ to indicate that a “read specification” word 712b, . . . 712m follows to define a number of words to be read in a burst mode.

TABLE 1
Address Word Control

| B[2:1] | Symbol | Description |
|---|---|---|
| 00 | C | Continue to next address word |
| 01 | W | Write |
| 10 | R1 | Read one word |
| 11 | RB | Read (burst) |

In some instances, each user data word 714 includes a 16-bit data value 724, a 2-bit control code 730, and an additional protocol-defined (P) bit 718c. Multiple user data words 714a, 714b, . . . 714n may be transmitted sequentially. An example of bit settings for control code 730 relating to write data is provided in Table 2. Examples of bit settings for the control code 730 relating to read data is provided in Table 3 and relating to burst read data is provided in Table 4.

TABLE 2
Write Data Word Control

| B[2:1] | Symbol | Description |
|---|---|---|
| 00 | C0 | Write to current address |
| 01 | C1 | Write to current address +1 |
| 10 | C2 | Write to current address +2 |
| 11 | E | End Write |

Multiple write data words can be sent sequentially. In Table 2, the value of the control code 730 provides an offset value for writing the next user data word 714b, . . . 714n. For example, a value ranging from binary ‘00’ to binary ‘10’ indicates that another write data word 714b, . . . 714n is to be written at the current location offset by the value of the control code 730. A control code 730 set to binary ‘11’ indicates that the current write data word 714a, 714b, . . . 714n is the last data 724 to be written. The next word expected may be a Slave ID word 710 to initiate a new transaction, or a control word 704 such as an “Exit” code word that may, for example, cause a change in master device on the serial bus 230, cause the serial bus 230 to enter an inactive state, initiate a change in mode of operation of the serial bus 230 (e.g. to I2C mode), or cause some other activity, change or event.

TABLE 3
Read Data Word Control

| B[2:1] | Symbol | Description |
|---|---|---|
| 00 | C | CRC |
| 01 | — | Reserved |
| 10 | — | Reserved |
| 11 | E | No CRC |

Table 3 relates to single data word 714 reads (see R1 in Table 1) in which only one read data word 714 is transmitted. The control code 730 may be used to determine whether a CRC is transmitted in the next data word 714. For example, the control code 730 may be set to binary ‘11’ if no CRC word 714 is to be transmitted after the current data word 714, and set to ‘00’ if a CRC word 714 is to be transmitted after the current data word 714.

TABLE 4
Burst Read Data Control

| B[2:1] | Symbol | Description |
|---|---|---|
| 00 | C | Continue |
| 01 | — | Reserved |
| 10 | — | Reserved |
| 11 | E | Last read word |

Table 4 relates to burst-mode reads of multiple data words 714 (see RB in Table 1). The control code 728 of an address word 712 may indicate that a “read specification” word follows the address word 712. The “read specification” word may include a 16-bit field, whereby the t=first transmitted bit (b₁₈) is set to binary ‘1’ when an unlimited number of bits are to be read, and set to ‘0’ when the remaining 15 bits (b₁₇-b₃) specify the number of data words 714 to be transmitted. A read data word 714 transmitted in RB mode may include a 16-bit read data value 724, a 2-bit control code 730, and an additional protocol-defined (P) bit 718c. The control code 730 of the read data word may be set to ‘11’ to indicate that the current read data word 714a, 714b, . . . 714n is the last read data word 714, and set to binary ‘00’ to indicate that the current read data word 714a, 714b, . . . 714n is not the last read data word 714.

The protocol may prohibit the slave node from sending more data words 714 (not including CRC words) than specified by the “read specification” word. The protocol may specify that the slave node send at least one read word 714 (not including CRC word). The slave node may end read transfers before transmitting the number of words specified by the “read specification” word.

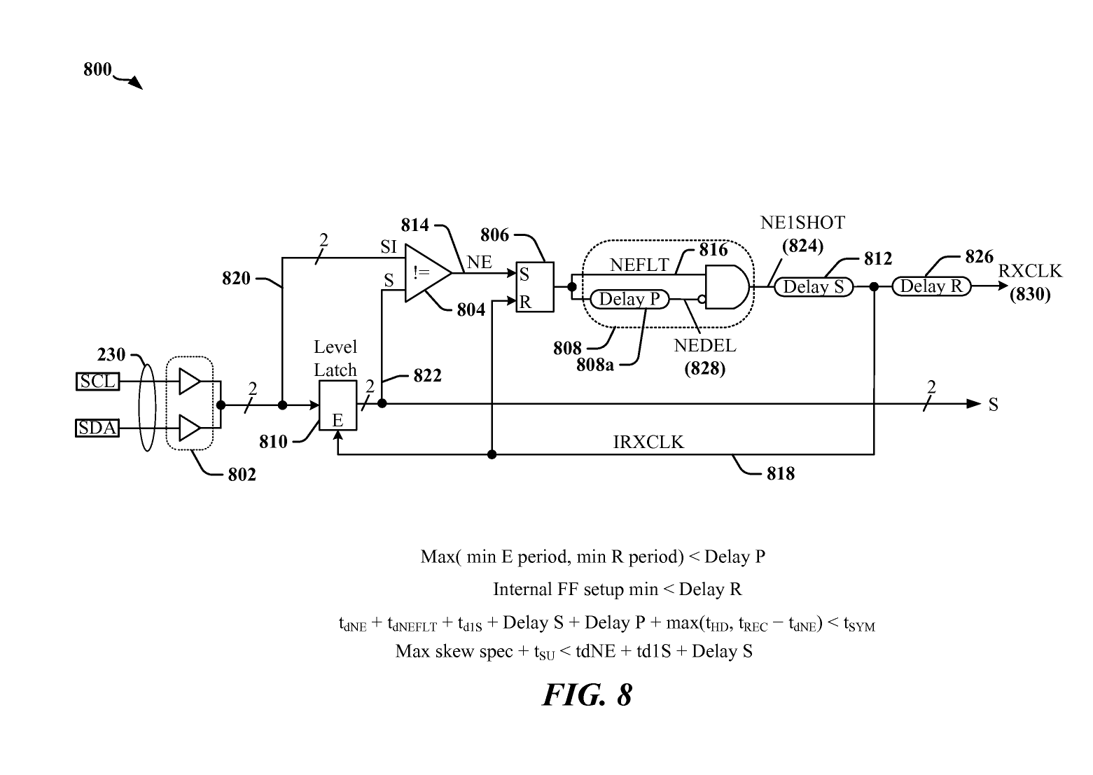

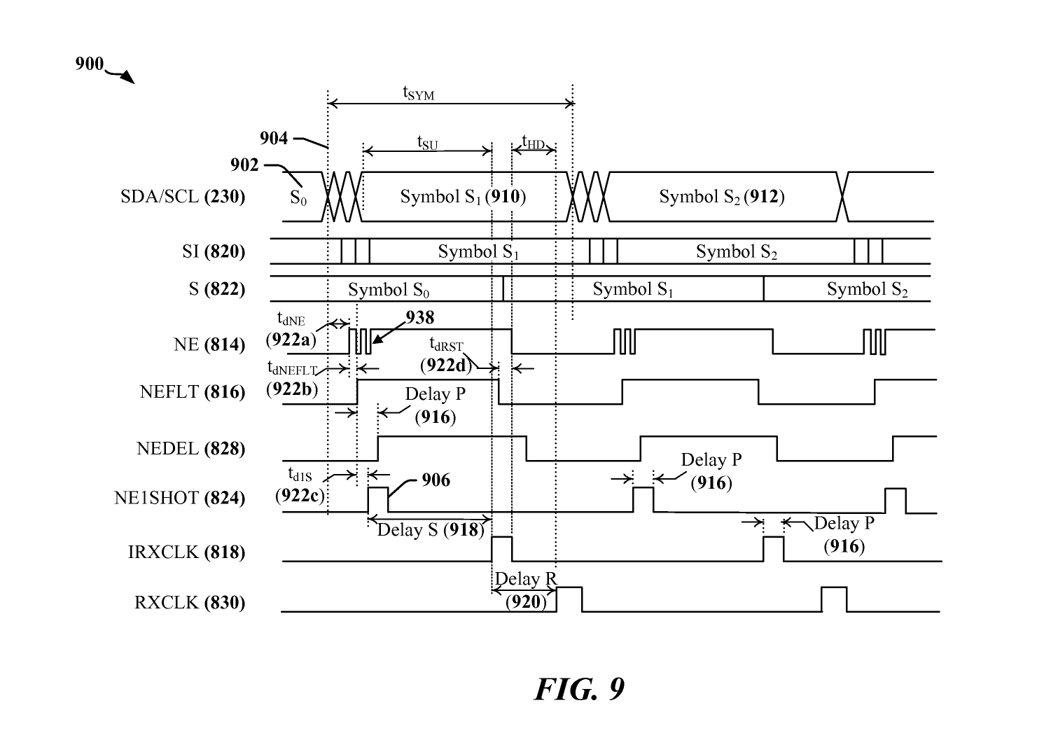

FIG. 8 illustrates one example of a CDR circuit 800 that may be used in accordance with one or more aspects disclosed herein and FIG. 9 shows an example of timing of certain signals generated by the CDR circuit 800. The CDR circuit 800 may be used in a CCIe transmission scheme where clock information is embedded in sequences of symbols transmitted on a CCIe bus 230. In one example, the CDR circuit 800 may be incorporated in the CDR 528 of the receiver 520 illustrated in FIG. 5. The CDR circuit 800 may include delay elements 808a, 812 and 826, which may include one or more analog delay elements. The delay elements 808a, 812 and 826 may be configured to maximize set up time for symbols 902, 910, 912 received from the CCIe bus 230. In the example, the CDR circuit 800 includes a comparator 804, a set-reset latch 806, a one-shot element 808 that includes a first delay element 808a, a second analog delay element 812, a third analog delay element 826 and a level latch 810. The comparator 804 may compare a two-bit input signal (SI signal) 820 that includes a stream of symbols 902, 910, 912 with a signal (S signal) 822 that is a level-latched instance of the SI signal 820. The comparator outputs a comparison (NE) signal 814. The set-reset latch 806 receives the NE signal 814 from the comparator 804 and outputs a filtered version (NEFLT signal 816) of the comparison signal 814. The first analog delay device 808a in the one-shot element 808 may receive the NEFLT signal 816 and outputs the NEDEL signal 828 that is a delayed version of the NEFLT signal 816. In operation, logic of the one-shot element 808 receives the NEFLT signal 816 and the delayed NEDEL signal 828 and outputs the NE1SHOT signal 824 that includes a pulse 906 triggered by the NEFLT signal 816.

The second analog delay device 812 receives the NE1SHOT signal 824 and outputs the IRXCLK signal 818. In some instances, an output clock signal 830 may be derived from the IRXCLK signal 818, using the third analog delay element 826 for example. The output clock signal 830 may be used for decoding the latched symbols in the S signal 822. The set-reset latch 806 may be reset based on the state of the IRXCLK signal 818. The level latch 810 receives the SI signal 820 and outputs the level-latched S signal 822, where the level latch 810 is enabled by the IRXCLK signal 818.

In operation, a transition 904 occurs between a current symbol (S₀) 902 and a next symbol (S₁) 910. The state of the SI signal 820 begins to change from a state corresponding to the current symbol 902 to a state corresponding to the next symbol (S₁) 910. Initially, the state of the SI signal 820 may differ from the state of the S₁ signal 910 due to the occurrence of intermediate or indeterminate states that may occur at and/or after the transition 904 from the current symbol S₀ 902 to the next symbol S₁ 910. Intermediate states may occur due to inter-wire skew, signal overshoot, signal undershoot, crosstalk, and so on. During the transition of the SI signal 820, the S signal 822 provides a delayed representation of the current symbol 902. The NE signal 814 transitions high when the comparator 804 detects different value between the SI signal 820 and the S signal 822, causing the set-reset latch 806 to be asynchronously set. Accordingly, the NEFLT signal 816 transitions high, and this high state is maintained until the set-reset latch 806 is reset by IRXCLK 818 transitioning to a high state. The IRXCLK signal 818 transitions to the high state in delayed response to the rising of the NEFLT signal 816, and the delay may be at least partially attributable to the operation of the delay element 812.

The intermediate states on the SI signal 820 may be regarded as invalid data and may include a short period when the SI signal reflects the value of the current symbol S₀ 902, causing the NE signal 814 (output by the comparator 804) to return towards a low state for short periods of time. Accordingly, spikes or transitions 938 may occur in the NE signal 814. The spikes 938 do not affect NEFLT signal 816 output by the set-reset latch 806, because the set-reset latch 806 remains set and effectively blocks and/or filters out the spikes 938 on the NE signal 814 from the NEFLT signal 816.

The one-shot circuit 808 outputs a high state in the NE1SHOT signal 824 after the rising edge of the NEFLT signal 816. The one-shot circuit 808 maintains the NE1SHOT signal 824 at a high state for the delay P period 916 before the NE1SHOT signal 824 returns to the low state. The resultant pulse 906 on the NE1SHOT signal 824 propagates to the IRXCLK signal 818 after the delay S period 918 caused by the analog delay S element 812. The high state of the IRXCLK signal 818 resets the set-reset latch 806, and the NEFLT signal 816 transitions low. The high state of IRXCLK signal 818 also enables the level latch 810 and the value of the SI signal 820 is output as the S signal 822.

The comparator 804 detects when the S signal 822 corresponds to the value of the next symbol 910. At this time, the S signal 822 matches the SI signal 820, and the output of the comparator 804 drives the NE signal 814 low. The trailing edge of the pulse 906 on the of NE1SHOT signal 824 propagates to the IRXCLK signal 818 after the delay S period 918 caused by the analog delay S element 812. The sequence repeats for further symbols (S₂) 912.

In one example, the output clock signal 830 is delayed by a Delay R period 920 by the third analog delay element 826. In some instances, the output clock signal 830 and the S signal 822 (data) may be provided to a decoder 424 or other circuit. The decoder 424 may sample the symbols on the S signal 822 using the output clock signal 830 or a derivative signal thereof.

In the illustrated example, various delays 922a, 922b, 922c, 922d may be attributable to switching times of various circuits, and/or attributable to rise times associated with links that may include, wires, conductive traces, connectors, etc. In order to provide adequate setup times for symbol capture by a decoder 424, the timing constraint for the symbol cycle period t_{SYM} may be defined as follows:

t_{dNE}+t_{dNEFLT}+t_{d1S}+Delay S+Delay P+max(t_{HD},t_{REC}−t_{dNE})<t_{SYM}

and the timing constraint for the setup time t_{SU} may be as follows:

Max skew spec+t_{SU}<tdNE+td1S+Delay S

where:
t_{syn}: one symbol cycle period,
t_{SU}: setup time of SI 820 for the level latches 810 referenced to the rising (leading) edge of IRXCLK 818,
t_{HD}: hold time of SI 820 for the level latches 810 referenced to the falling (trailing) edge of IRXCLK 818,
t_{dNE}: propagation delay of the comparator 804,
t_{dRST}: reset time of the set-reset latch 806 from the rising (leading) edge of IRXCLK 818.

The CDR circuit 800 may employ analog delay circuits 808a, 812 and 826 to ensure that a receiver 520 may decode CCIe encoded symbols without using a high-frequency free-running system clock. Accordingly, a CCIe slave device 202 (see FIG. 2) may be adapted to use the transmit clock 228 as a system clock when responding to a CCIe READ command, and a receive clock 538 generated by the CDR 528 (see FIG. 5) when dormant or receiving data. In one example, the transmit clock 228 may be a double data rate (DDR) clock that has a frequency of 10 MHz. In another example, the transmit clock may be a single data rate (SDR) clock that has a frequency of 20 MHz.

In some instances, a startup time may be provided for one or more internally generated transmit clocks 228 (see Clock Generator circuit 208 of FIG. 2) or the CDR circuit 800. A slave device 202 may stretch the START condition on the CCIe bus 230 by manipulating signaling until the transmit clock (TXCLK) 228 has stabilized after a CCIe read request has been received. The stretched START condition can occur before the first CCIe READ word is transmitted by the slave device 202, after the last address word is received by the slave device 202 (during turnaround of the CCIe bus 230). This stretching does not impair the operation or synchronization of the CCIe bus system. Additionally or alternatively, the CCIe master 220 may transmit dummy CCIe WRITE commands if a CCIe slave 202 needs some additional clock cycles to process data that is newly written.

In certain low-power applications, a slave device 202 may turn on the transmit clock 228 only during CCIe READ operations. The slave device 202 may use a receive clock recovered by the CDR circuit 528 (see FIG. 5) to maintain synchronization with the serial bus and/or to control certain operations performed by the slave device 202 during periods of low-power operation.

The CCIe master device 220 may also enter a low-power mode of operation, and may cause the CCIe bus 230 to enter an idle and/or sleep period. According to certain aspects disclosed herein, the CCIe master 220 may provide a lower-frequency “heartbeat clock” during low-power, idle and/or sleep periods. The heartbeat clock may enable slave devices 202, 222a-222n to maintain synchronization with the serial bus 230 and/or other devices 202, 220, 222a-222n attached to the serial bus 230. The heartbeat clock may be used by a slave device 202, 222a-222n to control certain activities during the low-power, idle and/or sleep periods.

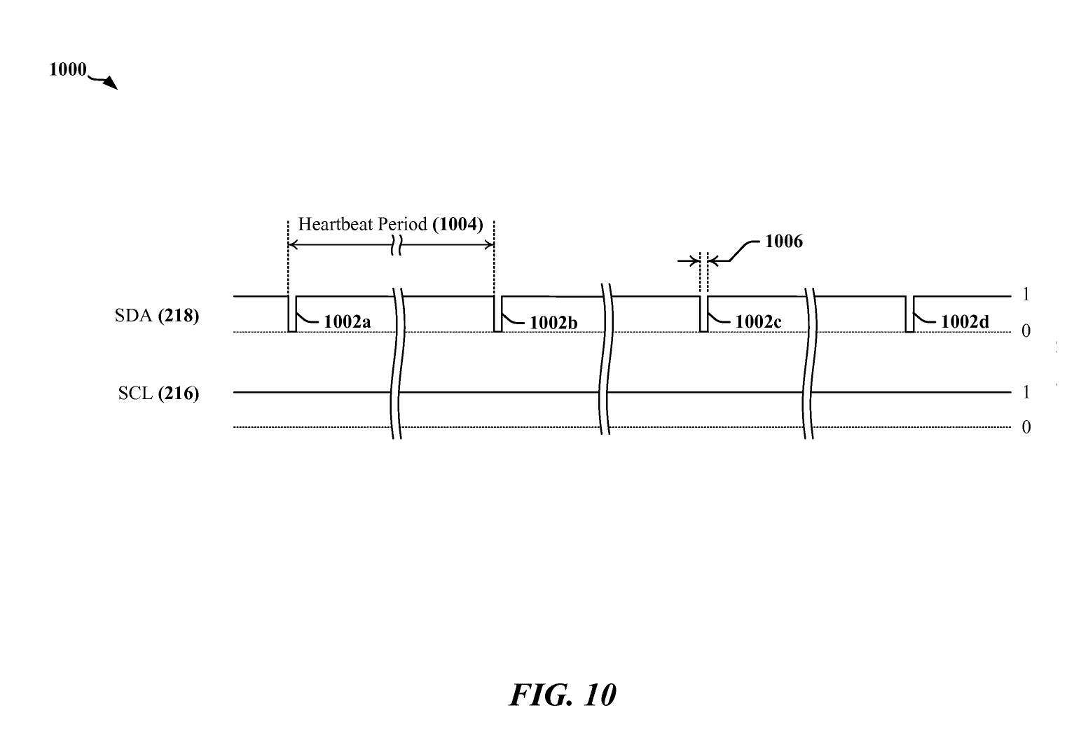

With reference to FIGS. 7 and 10-12, a control word 704 defined according to certain aspects disclosed herein may be used to provide a heartbeat clock 1000 (see FIG. 10). The heartbeat clock 1000 may provide pulses 1002a, 1002b, 1002c, 1002d that have relatively short duration 1006 and that are separated by relatively large periods of time 1004. In one example, the pulses 1002a, 1002b, 1002c, 1002d may be defined with a two-symbol duration of 2×50 ns=100 ns, and the pulses may be separated by 30 microseconds (30 μs), thereby providing a heartbeat clock with a frequency of 33.33 kHz. In this example, the CCIe slave devices 202, 222a-222n may use the 33.33 kHz clock extracted from heartbeat words for various standby operations.

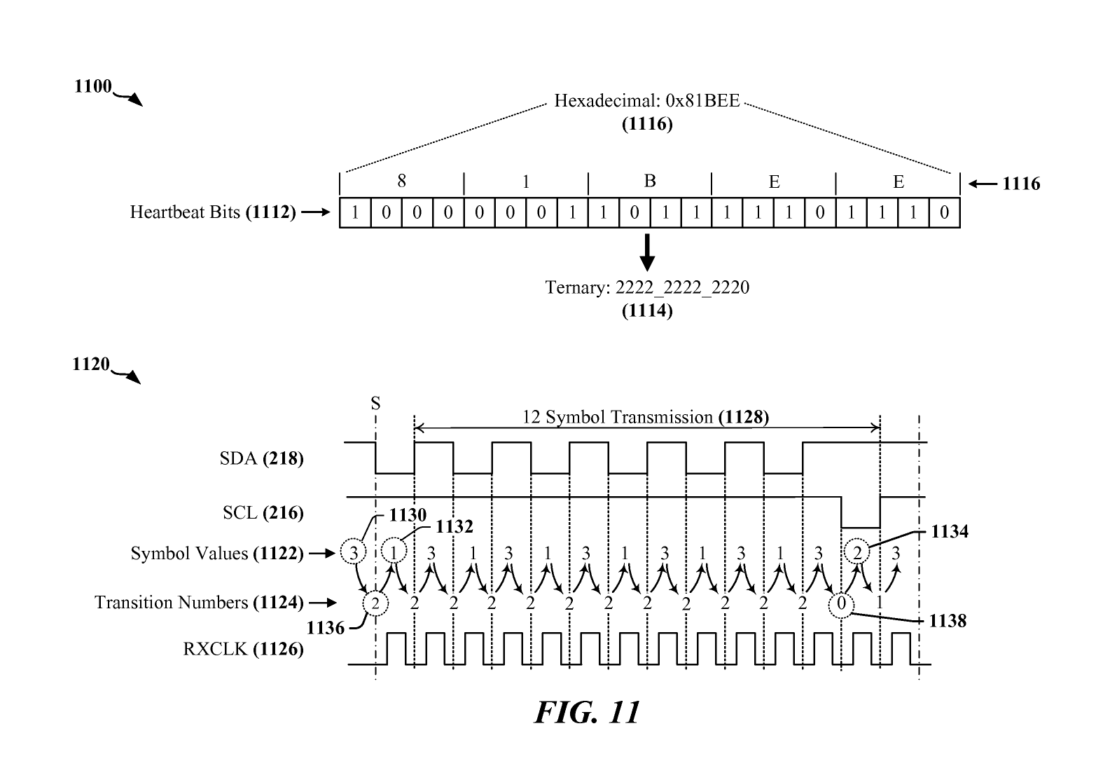

FIG. 11 illustrates an example 1100 of a control word 1116 that may be transmitted in compliance with CCIe protocols, and in a manner that enables the CCIe slave devices 202, 222a-222n to generate a heartbeat clock, including the heartbeat clock 1000 illustrated in FIG. 10. In one example, the control word 1116 may be expressed as the hexadecimal number 0x81BEE, which produces a bit pattern 1112 that is mapped to a set of 12 transition numbers 1114 that may be encapsulated with start condition values to produce a set of 14 transition numbers 1124 calculated to produce a 12-symbol sequence 1128 that is provided in a stream of symbols 1122. As illustrated in the timing diagram 1120, every other symbol 1130 of the 12-symbol sequence 1128 has a value of ‘3’ which results in a high voltage level on both the SDA signal wire 218 and the SCL signal wire 216. In the example, minimal currents may flow in the SDA signal wire 218 and the SCL signal wire 216 when both the SDA signal wire 218 and the SCL signal wire 216 are in the high state. A symbol value of ‘3’ may minimize power consumption associated with the serial bus 230. The 12-symbol sequence 1122 also includes symbols 1132, 1134 that have the value ‘1’ or ‘2,’ which cause either the SDA signal wire 218 or the SCL signal wire 216 to be driven low, while the other of the SDA signal wire 218 or the SCL signal wire 216 remains high. In each 12-symbol transmission 1128, one symbol 1134 may be provided with a value of ‘2,’ while the remaining symbols 1132 have a value of ‘1.’ As a result, the heartbeat control word 1116 produces 6 pulses on the SDA signal wire 218 and one pulse on the SCL signal wire 216 each time the control word 1116 is transmitted. In one example, a 1.43 MHz clock may be provided on the SCL signal wire 216 by repetitively transmitting the heartbeat control word 1116.

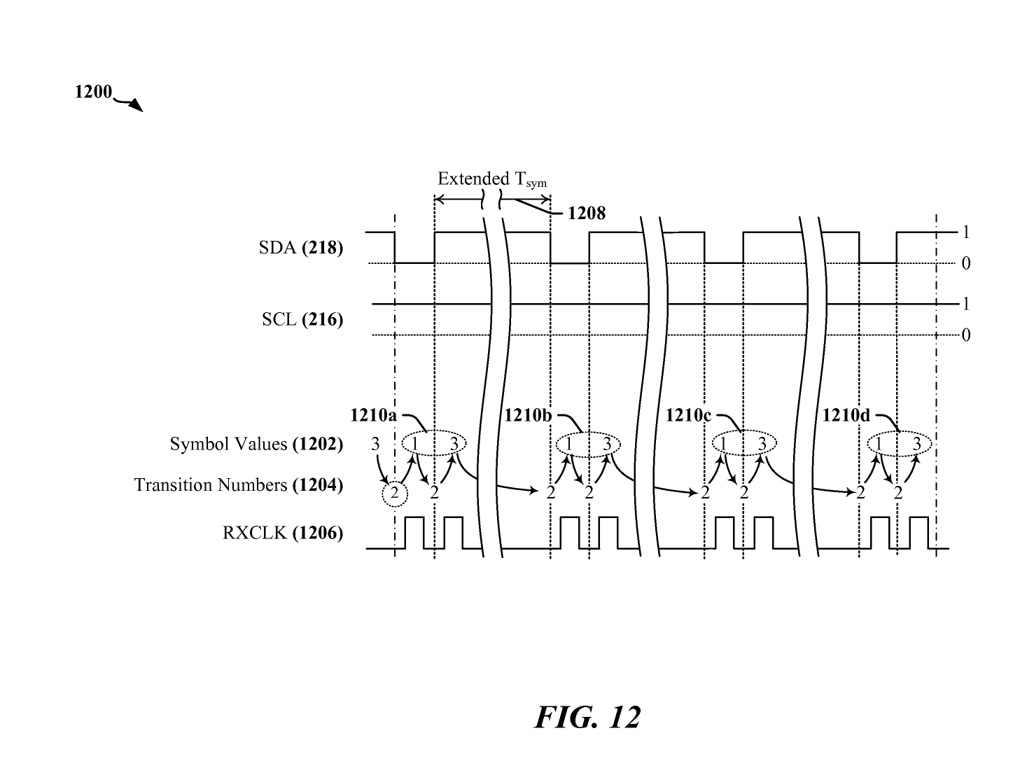

FIG. 12 illustrates an example in which a reduced frequency heartbeat clock may be provided by introducing a delay between groups of symbols in the stream of symbols 1202 corresponding to the 12-symbol sequence 1122 illustrated in FIG. 11. In the example, a delay is introduced after transmission of each symbol pair {1, 3} 1210a, 1210b, 1210c, 1210d to obtain an extended symbol interval 1208 for the second symbol in the symbol pair {1, 3} 1210a, 1210b, 1210c, 1210d during which both the SDA signal wire 218 and the SCL signal wire 216 in the high state. The transmission of a three-symbol group of symbols including the symbol pair {1, 3} 1210a, 1210b, 1210c, 1210d provides a pulse on the SDA signal wire 218.

The reduced-frequency heartbeat clock 1000 may be used as a clock source for various functional elements by low-power CCIe slave devices 202, 222a-222n that are equipped with a CDR 528 (see FIG. 5) in accordance with certain aspects disclosed herein. The reduced-frequency heartbeat clock 1000 may be provided on the CCIe bus 230 during periods in which the CCIe bus 230 is dormant or idled. The heartbeat clock 1000 may be provided at a frequency of 32.768 kHz while complying with CCIe protocols governing word format on the CCIe bus 230. The CCIe master 220 may repetitively transmit the same valid word on the CCIe bus 230 for prolonged idle or dormant periods. Dormant or hibernating slave devices 202, 222a-222n may monitor the CCIe bus 230 for a startup sequence that is transmitted by the master CCIe device 220. The startup sequence may include transmission of a start condition 416 (see FIG. 4) generated by driving the SDA signal 218 low for a minimum time period while the SCL signal 216 is maintained in a high state. In the example depicted, the heartbeat clock 1000 may provide a pulse on the SDA signal wire 218 for less than the minimum time period required for wakeup. In this manner, the heartbeat clock 1000 is provided as a result of transmitting valid CCIe words while preventing unintended wakeup signaling.

Wake-up detection circuitry in the slave device 202, 222a-222n may be configured to initiate wakeup when the SDA signal 218 is pulled low for a minimum predetermined period of time. In an example described herein, the heartbeat period is configured for 30 μs, and the minimum period for wakeup may be defined as a time greater than the half-cycle time (i.e. greater than 15 μs) of the SDA signal 218 during receipt of the heartbeat clock 1000. Accordingly, the heartbeat signal 1000 does not cause the slave device 202, 222a-222n to awaken. The receiver 520 in a dormant slave device 202, 222a-222n may use a recovered receive clock 1126, 1206 when external clock sources and system clocks are disabled or otherwise unavailable.

As disclosed herein, the heartbeat clock 1000 may be generated by encoding a CCIe control word 704 that is mapped to a desired sequence of transition numbers. In the example depicted in FIGS. 11 and 12, the CCIe control word 704 has a hexadecimal value of 0x81BEE that maps to a sequence of transition numbers, represented as the ternary number ‘2222_{—}2222_{—}2220.’ Other control words 704 may be used. In one other example, a heartbeat clock may be generated from a CCIe control word 704 that has a hexadecimal value of 0x81BFO.

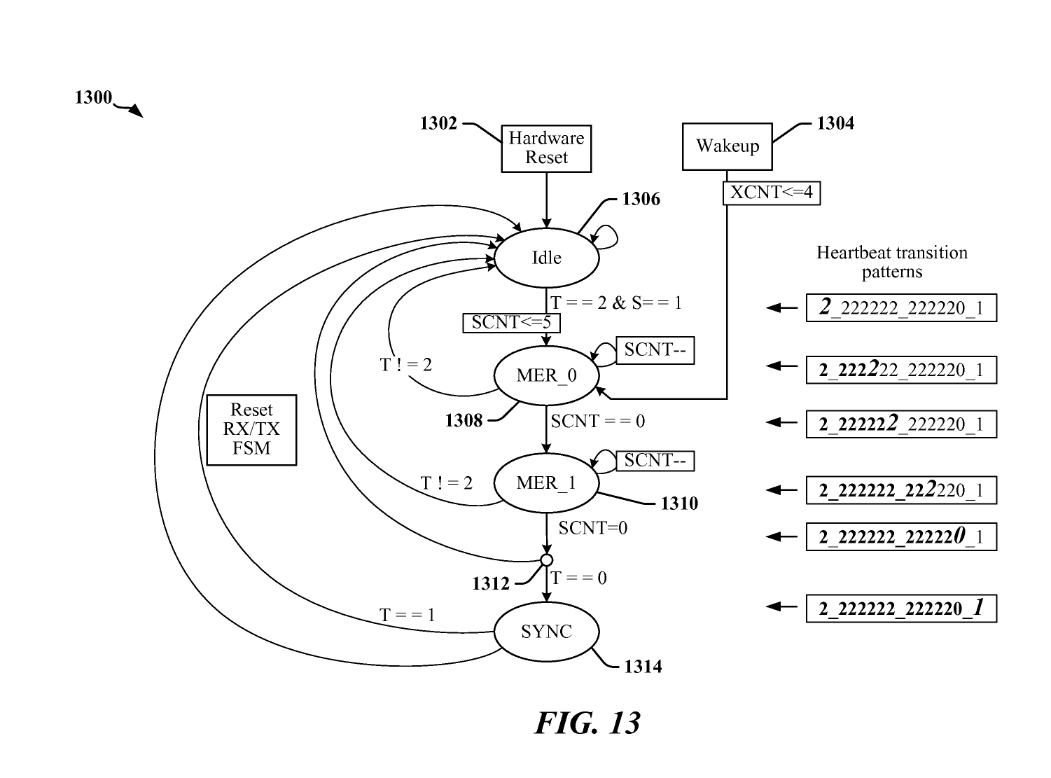

FIG. 13 includes a state diagram 1300 illustrating a method of detecting a CCIe sync/heartbeat word 1116 in order to perform a synchronization of a CCIe slave device 202, 222a-222n. In some instances, a dormant CCIe slave device 202, 222a-222n and/or a CCIe slave device 202, 222a-222n that has been reset may lose synchronization with the CCIe bus 230. The unsynchronized CCIe slave device 202, 222a-222n may attempt to reacquire synchronization while the CCIe bus is in an idle mode of operation. In some instances, the sync/heartbeat word 1116 may be selected to produce a unique pattern of transition numbers 1124 in the receiver of the unsynchronized CCIe slave device 202, 222a-222n. The unsynchronized CCIe slave device 202, 222a-222n may be configured to recognize the unique pattern of transition numbers 1124 corresponding to the sync/heartbeat word 1116.

In operation, a state machine controlled in accordance with the state diagram 1300 may be clocked by the receive clock 1126 generated from the heartbeat clock 1000. Each state transition may correspond to a clock pulse in the heartbeat clock 1000. The state machine may be initialized by a hardware reset 1302, although entry to synchronization process may be initiated by a wakeup 1304 initiated by a master device 220. The state machine may initially be in a first state, which may an idle state 1306. In the idle state 1306, the state machine may monitor transition numbers decoded from the serial bus 230. The state machine may be configured to detect the presence of one of the repeated transition number 1136 in the sequence of transition numbers received from the serial bus 230. In the example depicted in FIG. 11, the state machine may progress to a second state 1308, setting a symbol counter (S) to an initial value of 1. The state machine remains at the second state 1308 until a predefined number of the repeated transition numbers 1136 have been consecutively received, or if a transition number other than the repeated transition number 1136 is received. If a different transition number is received, the state machine may return to the idle state 1306. If a predefined number of the repeated transition numbers 1136 have been consecutively received, the state machine may determine that the serial bus 230 may be carrying the sync/heartbeat word 1116, and the state machine may progress to a third state 1310 to wait for a remaining number of consecutively received repeated transition numbers 1136. If a different transition number is received, the state machine may return to the idle state 1306. If the remaining number of repeated transition numbers 1136 are consecutively received, the state machine may determine 1312 whether the next received transition number corresponds to the last transition number 1138 in the synchronization transition numbers 1124 (here, a ‘0’). If the state machine determines such correspondence, the state machine may enter a synchronization state 1312 before returning to the idle state 1306 in a synchronized mode of operation. Otherwise, the state machine may return to the idle state 1306 in an unsynchronized mode of operation.

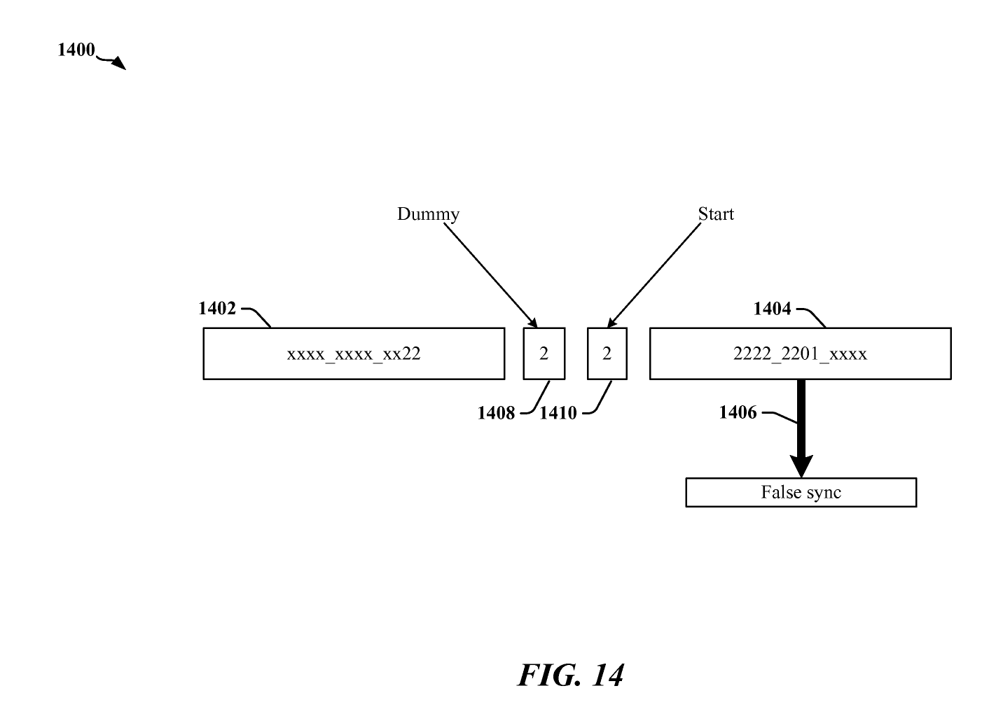

The CCIe sync/heartbeat word 1116 may be selected to provide a unique sequence of symbols and/or transitions that does not otherwise occur in legal CCIe words. In some instances, the unique sequence of symbols and/or transitions may occur when portions of two different sequences of symbols transmitted consecutively combine to mimic the unique sequence of symbols and/or transitions. FIG. 14 illustrates an example of a combination of transmissions 1400 that may mimic the unique sequence of transitions 1124 associated with the CCIe sync/heartbeat word 1116. In this example, the heartbeat clock 1000 may be generated from a CCIe control word 1116 that maps to a sequence of transition numbers 1124, represented as the ternary number (‘2222_{—}2222_{—}2220’) 1114. The ternary number 1114 may be mimicked by transmission of a pair of sequential legal CCIe words 1402 and 1404 separated by a dummy symbol 1408 that follows the first CCIe word 1402, and a start sequence 1410. This combination of symbols may cause a state machine to incorrectly determine that a CCIe sync/heartbeat word 1116 has been received. In particular, at a point 1406 during the transmission of the second CCIe word 1404, the state machine executing the state diagram 1300 may incorrectly enter a synchronized mode of operation without having attained synchronization.

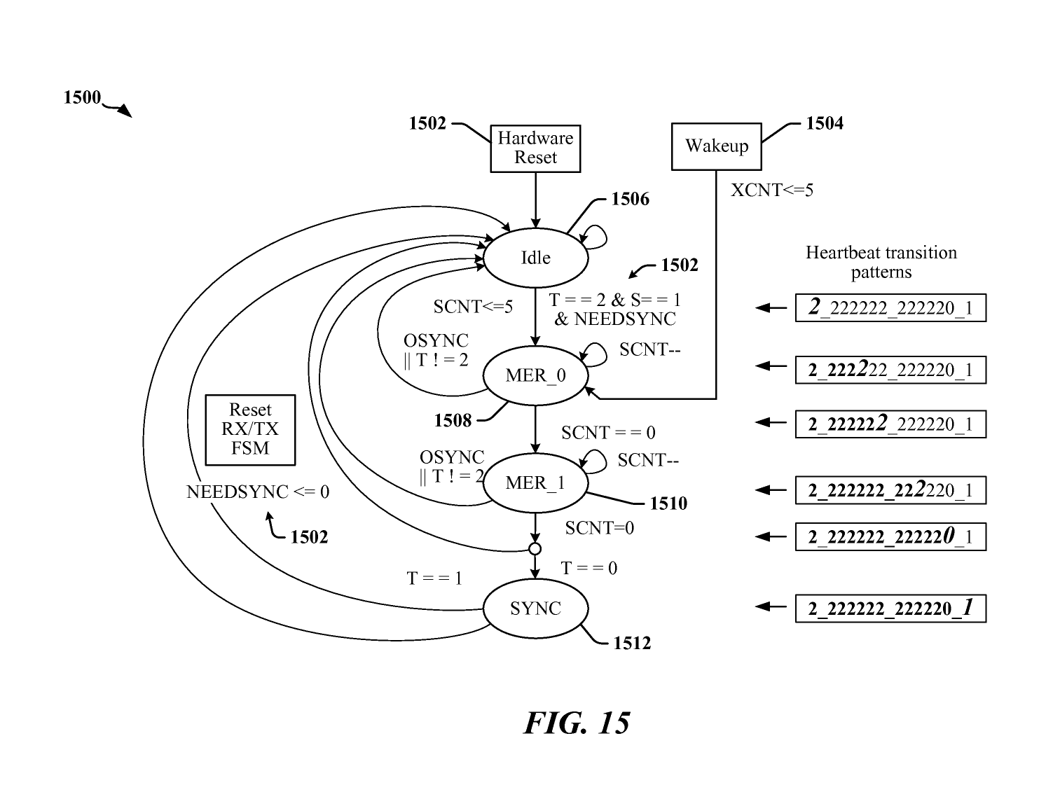

FIG. 15 is a state diagram 1500 illustrating a method of detecting the CCIe sync/heartbeat word 1116 without responding to a combination of transmissions 1400 that may mimic the unique sequence of transitions 1124, as illustrated in the example of FIG. 11. Differences between the state diagram 1500 of FIG. 15 and the state diagram 1300 of FIG. 13 include the use of a NEEDSYNC flag. For example, a state machine operated in accordance with the state diagram 1500 may remain in an idle state 1506 unless the “NEEDSYNC” flag is set (see condition 1502). The NEEDSYNC flag may be set after a hardware reset 1502 or after an error is detected in a received word. The error may be caused by a protocol error, or other out-of-synchronization condition, which may be detected through invalid start sequences, failed parity checks, error detection constant checks, redundancy checks, and/or an invalid address or command field value.

In one or more aspects of the disclosure, a heartbeat signal 1000, including heartbeat signals that can be used for synchronizing one or more of the slave devices 202, 222a-222n, may be sent only between CCIe frames 700 (see FIG. 7) transmitted on the CCIe bus 230. According to certain aspects, the CCIe frame 700 commences with a slave ID (SID) word 710 identifying a slave device 202, 222a-222n. The CCIe frame 700 may include one or more data words 714a, 714b, . . . 714n for reading or writing. Frame boundaries may be defined as the start 716 preceding the SID 710 and the end of the last data word 714a, 714b, . . . 714n. For example, synchronization or heartbeat symbols 1116 may be transmitted after the last data write/read data word 714a, 714b, . . . 714n and before next SID word 710. A slave 202, 222a-222n can use synchronization information in the synchronization or heartbeat symbols to find the next frame boundary after the slave 202, 222a-222n loses synchronization.

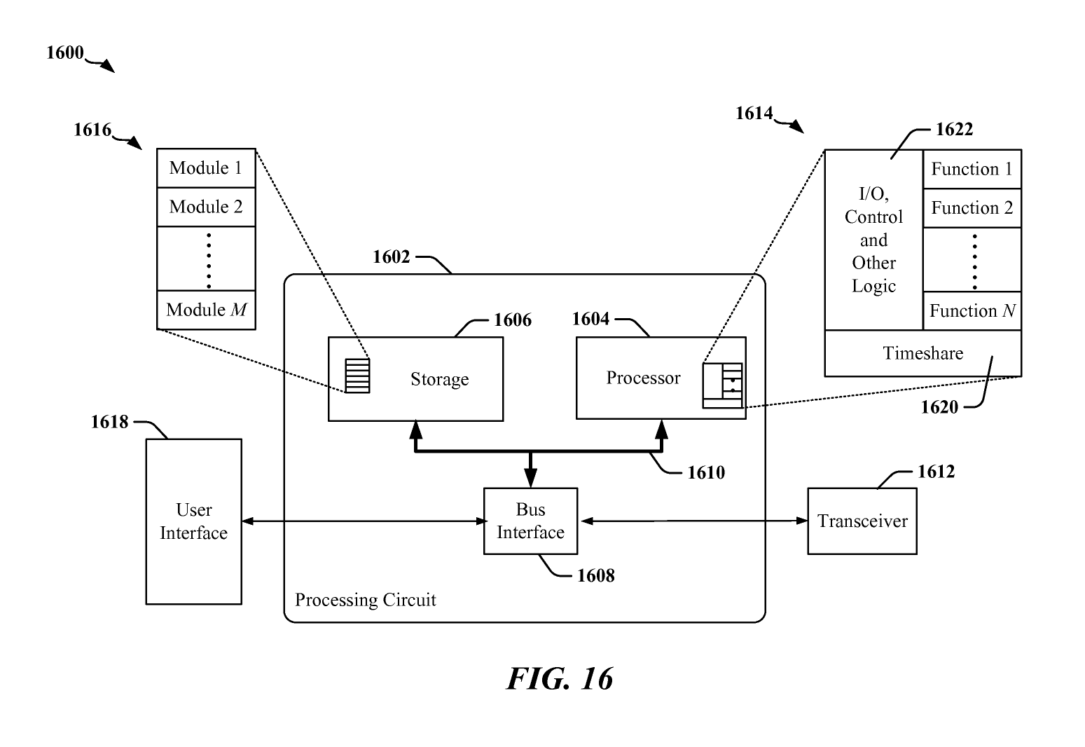

FIG. 16 is a conceptual diagram 1600 illustrating a simplified example of a hardware implementation for an apparatus employing a processing circuit 1602 that may be configured to perform one or more functions disclosed herein. For example, the processing circuit may be deployed as the processing circuit 102 of FIG. 1, at least a portion of the device 202 or the device 230 of FIG. 2, etc. In accordance with various aspects of the disclosure, an element, or any portion of an element, or any combination of elements as disclosed herein may be implemented using the processing circuit 1602. The processing circuit 1602 may include one or more processors 1604 that are controlled by some combination of hardware and software modules. Examples of processors 1604 include microprocessors, microcontrollers, digital signal processors (DSPs), field programmable gate arrays (FPGAs), programmable logic devices (PLDs), state machines, sequencers, gated logic, discrete hardware circuits, and other suitable hardware configured to perform the various functionality described throughout this disclosure. The one or more processors 1604 may include specialized processors that perform specific functions, and that may be configured, augmented or controlled by one of the software modules 1616. The one or more processors 1604 may be configured through a combination of software modules 1616 loaded during initialization, and further configured by loading or unloading one or more software modules 1616 during operation.

In the illustrated example, the processing circuit 1602 may be implemented with a bus architecture, represented generally by the bus 1610. The bus 1610 may include any number of interconnecting buses and bridges depending on the specific application of the processing circuit 1602 and the overall design constraints. The bus 1610 links together various circuits including the one or more processors 1604, and storage 1606. Storage 1606 may include memory devices and mass storage devices, and may be referred to herein as computer-readable media and/or processor-readable media. The bus 1610 may also link various other circuits such as timing sources, timers, peripherals, voltage regulators, and power management circuits. A bus interface 1608 may provide an interface between the bus 1610 and one or more transceivers 1612. A transceiver 1612 may be provided for each networking technology supported by the processing circuit. In some instances, multiple networking technologies may share some or all of the circuitry or processing modules found in a transceiver 1612. Each transceiver 1612 provides a means for communicating with various other apparatus over a transmission medium. Depending upon the nature of the apparatus, a user interface 1618 (e.g., keypad, display, speaker, microphone, joystick) may also be provided, and may be communicatively coupled to the bus 1610 directly or through the bus interface 1608.

A processor 1604 may be responsible for managing the bus 1610 and for general processing that may include the execution of software stored in a computer-readable medium that may include the storage 1606. In this respect, the processing circuit 1602, including the processor 1604, may be used to implement any of the methods, functions and techniques disclosed herein. The storage 1606 may be used for storing data that is manipulated by the processor 1604 when executing software, and the software may be configured to implement any one of the methods disclosed herein.

One or more processors 1604 in the processing circuit 1602 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1606 or in an external computer readable medium. The external computer-readable medium and/or storage 1606 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium and/or storage 1606 may also include, by way of example, a carrier wave, a transmission line, and any other suitable medium for transmitting software and/or instructions that may be accessed and read by a computer. Computer-readable medium and/or the storage 1606 may reside in the processing circuit 1602, in the processor 1604, external to the processing circuit 1602, or be distributed across multiple entities including the processing circuit 1602. The computer-readable medium and/or storage 1606 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1606 may maintain software maintained and/or organized in loadable code segments, modules, applications, programs, etc., which may be referred to herein as software modules 1616. Each of the software modules 1616 may include instructions and data that, when installed or loaded on the processing circuit 1602 and executed by the one or more processors 1604, contribute to a run-time image 1614 that controls the operation of the one or more processors 1604. When executed, certain instructions may cause the processing circuit 1602 to perform functions in accordance with certain methods, algorithms and processes described herein.

Some of the software modules 1616 may be loaded during initialization of the processing circuit 1602, and these software modules 1616 may configure the processing circuit 1602 to enable performance of the various functions disclosed herein. For example, some software modules 1616 may configure internal devices and/or logic circuits 1622 of the processor 1604, and may manage access to external devices such as the transceiver 1612, the bus interface 1608, the user interface 1618, timers, mathematical coprocessors, and so on. The software modules 1616 may include a control program and/or an operating system that interacts with interrupt handlers and device drivers, and that controls access to various resources provided by the processing circuit 1602. The resources may include memory, processing time, access to the transceiver 1612, the user interface 1618, and so on.

One or more processors 1604 of the processing circuit 1602 may be multifunctional, whereby some of the software modules 1616 are loaded and configured to perform different functions or different instances of the same function. The one or more processors 1604 may additionally be adapted to manage background tasks initiated in response to inputs from the user interface 1618, the transceiver 1612, and device drivers, for example. To support the performance of multiple functions, the one or more processors 1604 may be configured to provide a multitasking environment, whereby each of a plurality of functions is implemented as a set of tasks serviced by the one or more processors 1604 as needed or desired. In one example, the multitasking environment may be implemented using a timesharing program 1620 that passes control of a processor 1604 between different tasks, whereby each task returns control of the one or more processors 1604 to the timesharing program 1620 upon completion of any outstanding operations and/or in response to an input such as an interrupt. When a task has control of the one or more processors 1604, the processing circuit is effectively specialized for the purposes addressed by the function associated with the controlling task. The timesharing program 1620 may include an operating system, a main loop that transfers control on a round-robin basis, a function that allocates control of the one or more processors 1604 in accordance with a prioritization of the functions, and/or an interrupt driven main loop that responds to external events by providing control of the one or more processors 1604 to a handling function.

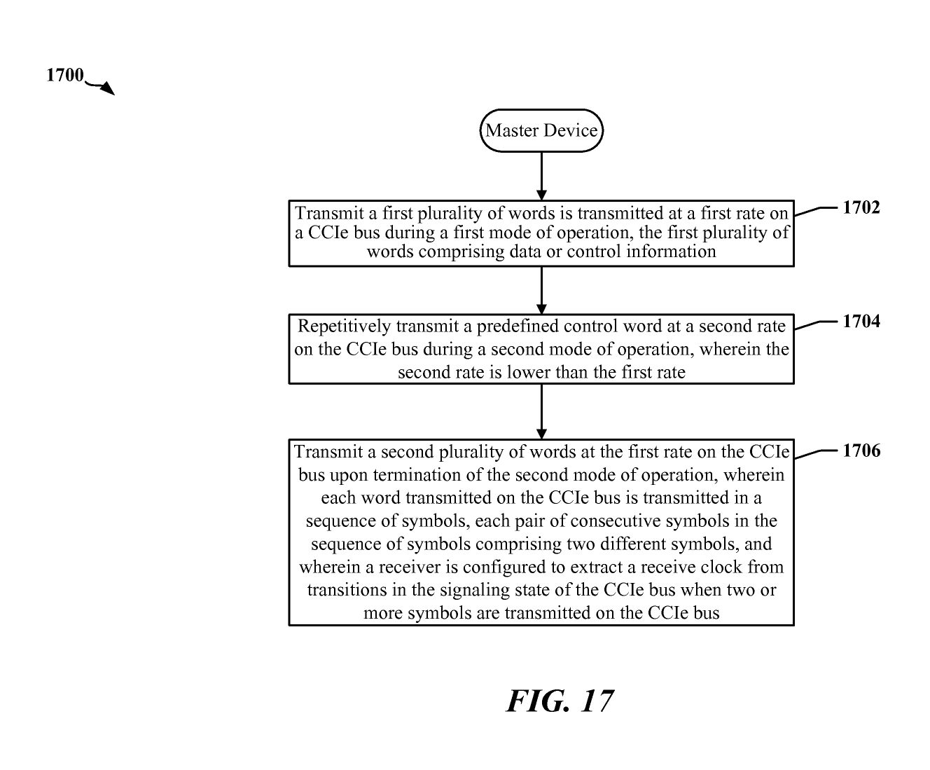

FIG. 17 includes a flowchart 1700 illustrating a method for data communications. The method may be performed by a CCIe master device 220, for example. At step 1702, a first plurality of words is transmitted at a first rate on a CCIe 230 bus during a first mode of operation. The first plurality of words may include data or control information.

At step 1704, a predefined control word may be repetitively transmitted at a second rate on the CCIe bus 230 during a second mode of operation. The second rate may be lower than the first rate. The predefined control word may cause a single pulse to be transmitted on a first wire of the CCIe bus 230 for each predefined control word transmitted on the CCIe bus 230. The second rate may be obtained by introducing delays between groups of symbols in a sequence of symbols corresponding to the predefined control word. The delays may be introduced between the groups of symbols such that both wires of the CCIe bus 230 are undriven for the duration of each delay.

At step 1706, a second plurality of words may be transmitted at the first rate on the CCIe bus 230 upon termination of the second mode of operation. Each word transmitted on the CCIe bus 230 may be transmitted in a sequence of symbols. Each pair of consecutive symbols in the sequence of symbols may include two different symbols. A receiver may be configured to extract a receive clock from transitions in the signaling state of the CCIe bus 230 when two or more symbols are transmitted on the CCIe bus 230.

In an aspect of the disclosure, the predefined control word generates a synchronization pattern in the signaling state of the CCIe bus 230. The predefined control word may be transmitted by transmitting a sequence of symbols corresponding to the predefined control word in groups of symbols. Each pair of consecutive groups of symbols may be separated by a delay. Each group of symbols may cause a pulse to be transmitted on a first wire of the CCIe bus 230, and may cause a signaling state of a second wire of the CCIe bus 230 to remain unchanged while the pulse is transmitted on the first wire.

In an aspect of the disclosure, the predefined control word may be transmitted by dividing the sequence of symbols corresponding to the predefined control word into groups of three symbols. For each group of three symbols, the group of three symbols may be transmitted on the CCIe bus 230 at a first symbol transmission rate, and transmission of a first symbol in a next group of three symbols may be delayed. Sequences of symbols corresponding to the first plurality of words may be transmitted at the first symbol transmission rate.

In an aspect of the disclosure, each symbol in the sequence of symbols determines the signaling state of at least two wires of the CCIe bus 230 while the symbol is transmitted on the CCIe bus 230.

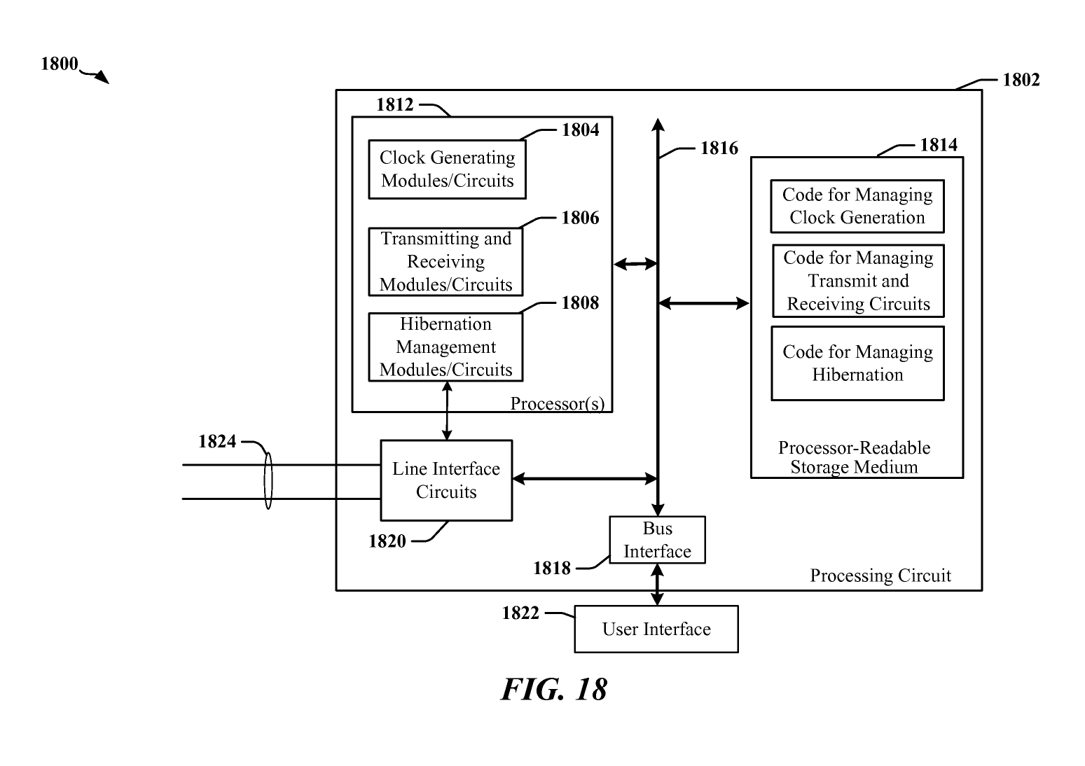

FIG. 18 is a conceptual diagram illustrating an example of a hardware implementation for an apparatus 1800 employing a processing circuit 1802. In this example, the processing circuit 1802 may be implemented with a bus architecture, represented generally by the bus 1816. The bus 1816 may include any number of interconnecting buses and bridges depending on the specific application of the processing circuit 1802 and the overall design constraints. The bus 1816 links together various circuits including one or more processors, represented generally by the processor 1812, line interface circuits 1820 configurable to communicate over connectors or wires 1824 and computer-readable media, represented generally by the processor-readable storage medium 1814. The bus 1816 may also link various other circuits such as timing sources, timers, peripherals, voltage regulators, and power management circuits. A bus interface 1818 provides an interface between the bus 1816. One or more transceivers (not shown) may provide a means for communicating with various other apparatus over a transmission medium. Depending upon the nature of the apparatus, a user interface 1822 (e.g., keypad, display, speaker, microphone, joystick) may also be provided. One or more clock generation circuits or modules 1824 may be provided within the processing circuit 1802 or controlled by processing circuit 1802 and/or one or more processors 1812. In one example, the clock generation circuits or modules 1824 may include one or more crystal oscillators, one or more phase-locked loop devices, and/or one or more configurable clock trees.

The processor 1812 is responsible for managing the bus 1816 and general processing, including the execution of software stored on the processor-readable storage medium 1814. The software, when executed by the processor 1812, causes the processing circuit 1802 to perform the various functions described supra for any particular apparatus. The processor-readable storage medium 1814 may be used for storing data that is manipulated by the processor 1812 when executing software.

In one configuration, the processing circuit may include a module and/or circuit 1804 that is configured to manage clock generation based on a current mode of operation, one or more modules and/or circuits 1806 configured to transmit and receive information using a serial bus 1824, and a module and/or circuit 1808 that is configured to manage functions and tasks performed while the apparatus is in a hibernation mode. In one example, the apparatus may transmit a first plurality of words at a first rate on the serial bus 1824 during a first mode of operation, repetitively transmit a predefined control word at a second rate on the serial bus 1824 during a second mode of operation, and transmit a second plurality of words at the first rate on the serial bus 1824 upon termination of the second mode of operation. The first plurality of words may include data or control information. The second rate may be lower than the first rate. Each word transmitted on the serial bus 1824 is transmitted in a sequence of symbols. Each pair of consecutive symbols in the sequence of symbols may include two different symbols. A receiver may be configured to extract a receive clock from transitions in the signaling state of the serial bus 1824 when two or more symbols are transmitted on the serial bus 1824.

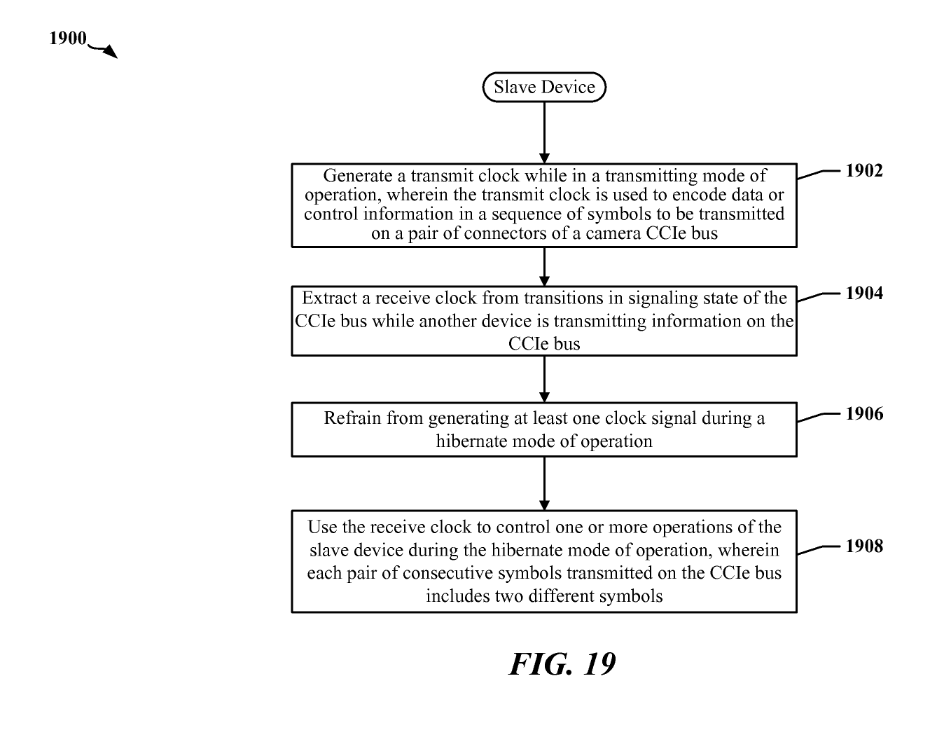

FIG. 19 includes a flowchart 1900 illustrating a method for data communications. The method may be performed by a CCIe slave device 202, for example. At step 1902, a transmit clock is generated while the device 202 is in a transmitting mode of operation. The transmit clock may be used to encode data or control information in a sequence of symbols to be transmitted on a pair of connectors of a CCIe bus 230.

At step 1904, a receive clock may be extracted from transitions in signaling state of the CCIe bus 230 while another device is transmitting information on the CCIe bus 230.

At step 1906, at least one clock signal may be suppressed, terminated, suspended or halted during a hibernate mode of operation.

At step 1908, the receive clock may be used to control one or more operations of the slave device during the hibernate mode of operation. Each pair of consecutive symbols transmitted on the CCIe bus 230 may include two different symbols.

In an aspect of the disclosure, the transmit clock may be suppressed when the slave device is not transmitting symbols on the CCIe bus 230. The receive clock may have a longer period when the CCIe bus 230 is in an idle mode of operation than when data or control information is transmitted between two nodes of the CCIe bus 230.

In an aspect of the disclosure, extracting the receive clock includes extracting a heartbeat clock from symbols transmitted on the CCIe bus 230 when the CCIe bus 230 is in an idle mode of operation. The heartbeat clock may be extracted from a sequence of symbols corresponding to a predefined control word. The heartbeat clock may have a lower frequency than a receive clock extracted from the CCIe bus 230 when data or control information is transmitted between two nodes of the CCIe bus 230.

In an aspect of the disclosure, a synchronization pattern may be determined in transitions of the signaling state of the CCIe bus 230. The synchronization pattern may be caused by a sequence of symbols corresponding to a predefined control word transmitted on the CCIe bus 230 when the CCIe bus 230 is in an idle mode of operation.

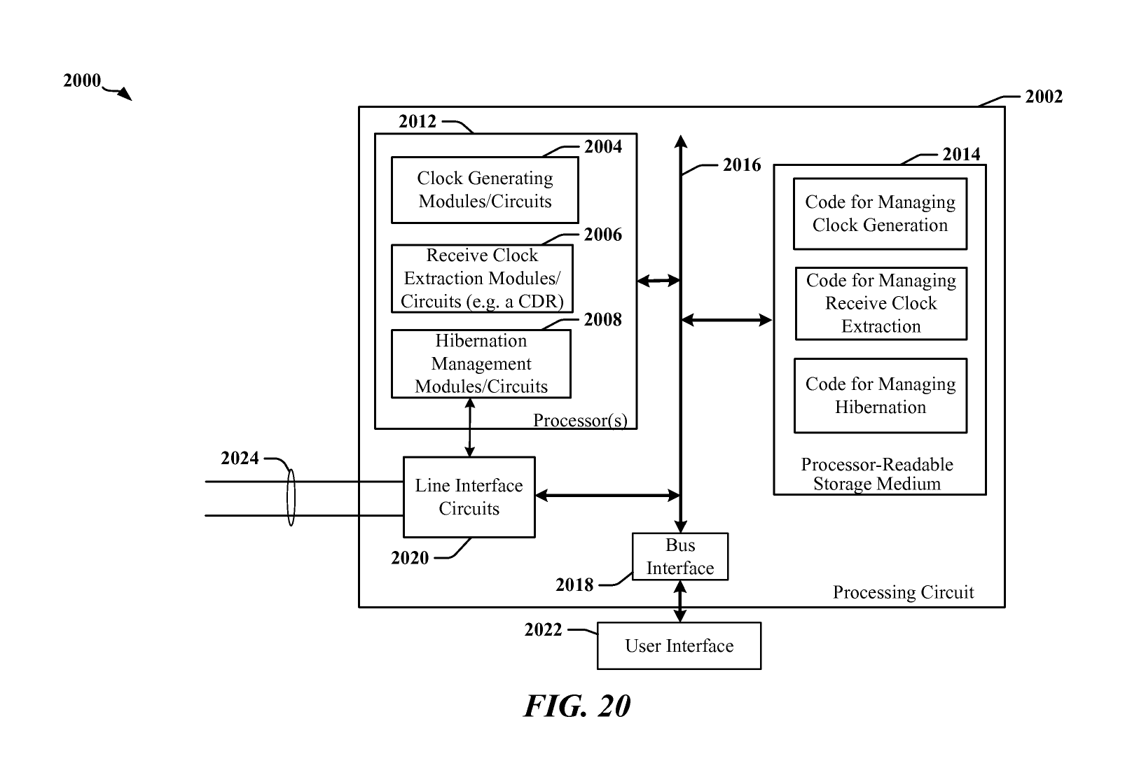

FIG. 20 is a conceptual diagram illustrating an example of a hardware implementation for an apparatus 2000 employing a processing circuit 2002. In this example, the processing circuit 2002 may be implemented with a bus architecture, represented generally by the bus 2016. The bus 2016 may include any number of interconnecting buses and bridges depending on the specific application of the processing circuit 2002 and the overall design constraints. The bus 2016 links together various circuits including one or more processors, represented generally by the processor 2012, line interface circuits 2020 configurable to communicate over connectors or wires 2024 and computer-readable media, represented generally by the processor-readable storage medium 2014. The bus 2016 may also link various other circuits such as timing sources, timers, peripherals, voltage regulators, and power management circuits. A bus interface 2018 provides an interface between the bus 2016. One or more transceivers (not shown) may provide a means for communicating with various other apparatus over a transmission medium. Depending upon the nature of the apparatus, a user interface 2022 (e.g., keypad, display, speaker, microphone, joystick) may also be provided. One or more clock generation circuits or modules 2024 may be provided within the processing circuit 2002 or controlled by processing circuit 2002 and/or one or more processors 2012. In one example, the clock generation circuits or modules 2024 may include one or more crystal oscillators, one or more phase-locked loop devices, and/or one or more configurable clock trees.

The processor 2012 is responsible for managing the bus 2016 and general processing, including the execution of software stored on the processor-readable storage medium 2014. The software, when executed by the processor 2012, causes the processing circuit 2002 to perform the various functions described supra for any particular apparatus. The processor-readable storage medium 2014 may be used for storing data that is manipulated by the processor 2012 when executing software.

In one configuration, the processing circuit may include a module and/or circuit 2004 that is configured to generate a transmit clock when the apparatus is transmitting over wires 2024 which may include a CCIe bus 230, a module and/or circuit 2006 configured to extract one or more receive clocks based on transitions on the wires 2024, and a module and/or circuit 2008 configured to manage a hibernation mode of operation when the apparatus is in an idle or dormant mode of operation. In one example, the apparatus may be configured to generate a transmit clock while in a transmitting mode of operation, extract a receive clock from transitions in signaling state of the wires 2024 while another device is transmitting information on the wires 2024, refrain from generating at least one clock signal during the hibernate mode of operation, and use the receive clock to control one or more operations of the slave device during the hibernate mode of operation.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of data communications, comprising:
transmitting a first plurality of words at a first rate on a camera control interface extension (CCIe) bus during a first mode of operation, the first plurality of words comprising data or control information;
repetitively transmitting a predefined control word at a second rate on the CCIe bus during a second mode of operation, wherein the second rate is lower than the first rate; and
transmitting a second plurality of words at the first rate on the CCIe bus upon termination of the second mode of operation,
wherein each word transmitted on the CCIe bus is transmitted in a sequence of symbols, each pair of consecutive symbols in the sequence of symbols comprising two different symbols, and
wherein a receiver is configured to extract a receive clock from transitions in signaling state of the CCIe bus when two or more symbols are transmitted on the CCIe bus.

2. The method of claim 1, wherein the predefined control word causes a single pulse to be transmitted on a first wire of the CCIe bus for each predefined control word transmitted on the CCIe bus.

3. The method of claim 1, wherein the second rate is obtained by introducing delays between groups of symbols in a sequence of symbols corresponding to the predefined control word.

4. The method of claim 3, wherein the delays are introduced between the groups of symbols such that both wires of the CCIe bus are undriven for during each delay.

5. The method of claim 1, wherein transmitting the predefined control word generates a synchronization pattern in the signaling state of the CCIe bus.

6. The method of claim 1, wherein transmitting the predefined control word comprises:
transmitting a sequence of symbols corresponding to the predefined control word in groups of symbols, wherein each pair of consecutive groups of symbols is separated by a delay.

7. The method of claim 6, wherein each group of symbols causes a pulse to be transmitted on a first wire of the CCIe bus and causes a signaling state of a second wire of the CCIe bus to remain unchanged while the pulse is transmitted on the first wire.

8. The method of claim 1, wherein transmitting the predefined control word comprises:
dividing the sequence of symbols corresponding to the predefined control word into groups of three symbols; and
for each group of three symbols:
transmitting the group of three symbols on the CCIe bus at a first symbol transmission rate; and
delaying transmission of a first symbol in a next group of three symbols.

9. The method of claim 8, wherein transmitting the first plurality of words includes transmitting sequences of symbols corresponding to the first plurality of words at the first symbol transmission rate.

10. The method of claim 1, wherein each symbol in the sequence of symbols determines the signaling state of at least two wires of the CCIe bus while the symbol is transmitted on the CCIe bus.

11. A method of data communications, comprising:
generating a transmit clock while in a transmitting mode of operation, wherein the transmit clock is used to encode data or control information in a sequence of symbols to be transmitted on a pair of connectors of a camera control interface extension (CCIe) bus;
extracting a receive clock from transitions in signaling state of the CCIe bus while another device is transmitting information on the CCIe bus;
refraining from generating at least one clock signal during a hibernate mode of operation; and
using the receive clock to control one or more operations during the hibernate mode of operation,
wherein each pair of consecutive symbols transmitted on the CCIe bus includes two different symbols.

12. The method of claim 11, further comprising:
refraining from generating the transmit clock when not transmitting symbols on the CCIe bus.

13. The method of claim 11, wherein the receive clock has a longer period when the CCIe bus is in an idle mode of operation than when data or control information is transmitted between two nodes of the CCIe bus.

14. The method of claim 11, wherein extracting the receive clock comprises:
extracting a heartbeat clock from symbols transmitted on the CCIe bus when the CCIe bus is in an idle mode of operation,
wherein the heartbeat clock is extracted from a sequence of symbols corresponding to a predefined control word, and
wherein the heartbeat clock has a lower frequency than a receive clock extracted from the CCIe bus when data or control information is transmitted between two nodes of the CCIe bus.

15. The method of claim 11, further comprising:
determining a synchronization pattern in transitions of the signaling state of the CCIe bus,
wherein the synchronization pattern is generated by a sequence of symbols corresponding to a predefined control word transmitted on the CCIe bus when the CCIe bus is in an idle mode of operation.

16. An apparatus configurable to operate as a slave device on a camera control interface bus, comprising:
a processing circuit configured to:
generate a transmit clock while in a transmitting mode of operation, wherein the transmit clock is used to encode data or control information in a sequence of symbols to be transmitted on a pair of connectors of a camera control interface extension (CCIe) bus;
extract a receive clock from transitions in signaling state of the CCIe bus while another device is transmitting information on the CCIe bus;
refrain from generating at least one clock signal during a hibernate mode of operation; and
use the receive clock to control one or more operations during the hibernate mode of operation,
wherein each pair of consecutive symbols transmitted on the CCIe bus includes two different symbols.

17. The apparatus of claim 16, wherein the processing circuit is configured to:
refrain from generating the transmit clock when not transmitting symbols on the CCIe bus.

18. The apparatus of claim 16, wherein the receive clock has a longer period when the CCIe bus is in an idle mode of operation than when data or control information is transmitted between two nodes of the CCIe bus.

19. The apparatus of claim 16, wherein the processing circuit is configured to:
extract a heartbeat clock from symbols transmitted on the CCIe bus when the CCIe bus is in an idle mode of operation,
wherein the heartbeat clock is extracted from a sequence of symbols corresponding to a predefined control word, and
wherein the heartbeat clock has a lower frequency than a receive clock extracted from the CCIe bus when data or control information is transmitted between two nodes of the CCIe bus.

20. The apparatus of claim 16, wherein the processing circuit is configured to:
determine a synchronization pattern in transitions of the signaling state of the CCIe bus,
wherein the synchronization pattern is generated by a sequence of symbols corresponding to a predefined control word transmitted on the CCIe bus when the CCIe bus is in an idle mode of operation.

21. An apparatus configurable to operate as a master device on a camera control interface bus, comprising:
a processing circuit configured to:
transmit a first plurality of words at a first rate on a camera control interface extension (CCIe) bus during a first mode of operation, the first plurality of words comprising data or control information;
repetitively transmit a predefined control word at a second rate on the CCIe bus during a second mode of operation, wherein the second rate is lower than the first rate; and
transmit a second plurality of words at the first rate on the CCIe bus upon termination of the second mode of operation,
wherein each word transmitted on the CCIe bus is transmitted in a sequence of symbols, each pair of consecutive symbols in the sequence of symbols comprising two different symbols, and
wherein a receiver is configured to extract a receive clock from transitions in signaling state of the CCIe bus when two or more symbols are transmitted on the CCIe bus.

22. The apparatus of claim 21, wherein the predefined control word causes a single pulse to be transmitted on a first wire of the CCIe bus for each predefined control word transmitted on the CCIe bus.

23. The apparatus of claim 21, wherein the second rate is obtained by introducing delays between groups of symbols in a sequence of symbols corresponding to the predefined control word.

24. The apparatus of claim 23, wherein the delays are introduced between the groups of symbols such that both wires of the CCIe bus are undriven during each delay.

25. The apparatus of claim 21, wherein transmitting the predefined control word generates a synchronization pattern in the signaling state of the CCIe bus.

26. The apparatus of claim 21, wherein the processing circuit is configured to transmit the predefined control word by:
transmitting a sequence of symbols corresponding to the predefined control word in groups of symbols, wherein each pair of consecutive groups of symbols is separated by a delay.

27. The apparatus of claim 26, wherein each group of symbols causes a pulse to be transmitted on a first wire of the CCIe bus and causes a signaling state of a second wire of the CCIe bus to remain unchanged while the pulse is transmitted on the first wire.

28. The apparatus of claim 21, wherein the processing circuit is configured to:
divide the sequence of symbols corresponding to the predefined control word into groups of three symbols; and
for each group of three symbols:
transmit the group of three symbols on the CCIe bus at a first symbol transmission rate; and
delay transmission of a first symbol in a next group of three symbols.

29. The apparatus of claim 28, wherein transmitting the first plurality of words includes transmitting sequences of symbols corresponding to the first plurality of words at the first symbol transmission rate.

30. The apparatus of claim 21, wherein each symbol in the sequence of symbols determines the signaling state of at least two wires of the CCIe bus while the symbol is transmitted on the CCIe bus.
